(19) United States
(12) Patent Application Publication
(10) Pub. No.: US 2020/0047480 A1
(43) Pub. Date: Feb. 13, 2020

(54) SHEETLIKE COMPOSITE, IN PARTICULAR FOR THE PRODUCTION OF DIMENSIONALLY STABLE FOODSTUFF CONTAINERS, HAVING A FIRST COLOUR APPLICATION AND A SECOND COLOUR APPLICATION WITH A 2D-CODE

(71) Applicant: SIG COMBIBLOC (SUZHOU) CO. LTD., Suzhou, Jiangsu (CN)

(72) Inventors: Miguel GAMITO, Suzhou, Jiangsu (CN); Jun SUN, Suzhou, Jiangsu (CN); Christian KÖNIG, Grevenbroich (DE)

(21) Appl. No.: 16/343,694

(22) PCT Filed: Oct. 19, 2017
(86) PCT No.: PCT/CN2017/106909

§ 371 Date: Oct. 7, 2019

(30) Foreign Application Priority Data
Oct. 21, 2016 (CN) 201610920073.1

(51) Int. Cl. B32B 38/00; B32B 15/085; B32B 27/10; B32B 15/20; B32B 37/02; B32B 37/15; B65D 5/06; B65D 5/42; B65D 5/56; B65D 5/62

(52) U.S. Cl. CPC B32B 38/145; B32B 15/085; B32B 27/10; B32B 15/20; B32B 37/02; B32B 7/12; B65D 5/064; B65D 5/4212; B65D 5/563; B65D 5/62; B32B 37/153

(57) ABSTRACT

Described is sheetlike composite comprising as layers of a layer sequence in a direction from an outer surface of the sheetlike composite to an inner surface of the sheetlike composite; a) an outer polymer layer, b) a carrier layer, and c) a barrier layer; wherein the sheetlike composite comprises a first composite region and a second composite region; wherein in the first composite region the sheetlike composite further comprises a first colour application, superimposing the outer polymer layer on a side of the outer polymer layer which is facing away from the inner surface of the sheetlike composite; wherein in the second composite region the sheetlike composite further comprises a second colour application, superimposing the outer polymer layer on the side of the outer polymer layer which is facing away from the inner surface of the sheetlike composite; wherein the second colour application comprises a 2D-code. Described is a process including steps of adapting an outer surface of a sheetlike composite precursor to a first value and to a further value, and steps of applying a first and a second ink composition to the outer surface; to a sheetlike composite obtainable by the process; to a container precursor and a closed container, each comprising a pre-cut section of one of the preceding sheetlike composites; to a use of one of the preceding sheetlike composites; and to a use of an inkjet printer.

### FIELD OF THE INVENTION

The present invention refers to a sheetlike composite, comprising as layers of a layer sequence in a direction from an outer surface of the sheetlike composite to an inner surface of the sheetlike composite
a) an outer polymer layer,
b) a carrier layer, and
c) a barrier layer;
   wherein the sheetlike composite comprises a first composite region and a second composite region; wherein in the first composite region the sheetlike composite further comprises a first colour application, superimposing the outer polymer layer on a side of the outer polymer layer which is facing away from the inner surface of the sheetlike composite; wherein in the second composite region the sheetlike composite further comprises a second colour application, superimposing the outer polymer layer on the side of the outer polymer layer which is facing away from the inner surface of the sheetlike composite; wherein the second colour application comprises a 2D-code. The invention further refers to a process, including steps of adapting an outer surface of a sheetlike composite precursor to a first value and to a further value, and steps of applying a first and a second ink composition to the outer surface; to a sheetlike composite obtainable by the process; to a container precursor and a closed container, each comprising a pre-cut section of one of the preceding sheetlike composites; to a use of one of the preceding sheetlike composites; and to a use of an inkjet printer.

### BACKGROUND OF THE INVENTION

For some time, foodstuffs have been preserved, whether they be foodstuffs for human consumption or else animal feed products, by storing them either in a can or in a jar closed by a lid. In this case, shelf life can be increased firstly by separately and very substantially sterilising the foodstuff and the container in each case, here the jar or can, and then introducing the foodstuff into the container and closing the container. However, these measures of increasing the shelf life of foodstuffs, which have been tried and tested over a long period, have a series of disadvantages, for example the need for another sterilisation later on. Cans and jars, because of their essentially cylindrical shape, have the disadvantage that very dense and space-saving storage is not possible. Moreover, cans and jars have considerable intrinsic weight, which leads to increased energy expenditure in transport. Moreover, production of glass, tinplate or aluminium, even when the raw materials used for the purpose are recycled, necessitates quite a high expenditure of energy. In the case of jars, an aggravating factor is elevated expenditure on transport. The jars are usually prefabricated in a glass factory and then have to be transported to the facility where the foodstuff is dispensed with utilisation of considerable transport volumes. Furthermore, jars and cans can be opened only with considerable expenditure of force or with the aid of tools and hence in a rather laborious manner. In the case of cans, there is a high risk of injury emanating from sharp edges that arise on opening. In the case of jars, it is a repeated occurrence that broken glass gets into the foodstuff in the course of filling or opening of the filled jars, which can lead in the worst case to internal injuries on consumption of the foodstuff. In addition, both cans and jars have to be labelled for identification and promotion of the foodstuff contents. The jars and cans cannot be printed directly with information and promotional messages. In addition to the actual printing, a substrate is thus needed for the purpose, a paper or suitable film, as is a securing means, an adhesive or sealant.

Other packaging systems are known from the prior art, in order to store foodstuffs over a long period with minimum impairment. These are containers produced from sheetlike composites—frequently also referred to as laminates. Sheetlike composites of this kind are frequently constructed from a thermoplastic plastic layer, a carrier layer usually consisting of cardboard or paper which imparts dimensional stability to the container, an adhesion promoter layer, a barrier layer and a further plastic layer, as disclosed inter alia in WO 90/09926 A2. As the carrier layer imparts rigidity and dimensional stability to the container produced from the laminate, these laminate containers are to be seen in a line of development with the above mentioned glasses and jars. In this the above mentioned laminate containers differ severely from pouches and bags produced from thin foils without carrier layer.

The laminate containers of the prior art already have many advantages over the conventional jars and cans. For example, a decoration or print image can be printed directly onto the laminate or laminate precursor without the need for separate substrate. Such a decoration may comprise information about ingredients of the foodstuff to be stored in the laminate container and/or provide a visually appealing appearance to the consumer. Nevertheless, there are improvement opportunities even in the case of these packaging systems. For example, there is a need for applying information to the laminate container which may be chosen individually for the foodstuff in the container. Typically, the decoration is printed by a printing process involving a printing roll—such as intaglio printing or flexographic printing. Hence, the decoration cannot be varied to individually suit a container.

### SUMMARY OF THE INVENTION

In general terms, it is an object of the present invention to at least partly overcome one disadvantage which arises from the prior art. It is a further object of the invention to provide a laminate for the production of dimensionally stable foodstuff containers and/or such a foodstuff container having a decoration and a machine readable symbol, wherein the symbol is reliably readable under various conditions, preferably under various lighting conditions. In this context, it is a further object of the invention that as much data as possible can be encoded into the symbol, preferably with as little impairment of the decoration as possible. Further in this context, it is an object of the invention that a content of the data encoded into the symbol can be chosen as flexible as possible. Preferably, the data can be chosen to individually fit the foodstuff to be stored in the container or to specifics of the individual process by which the laminate or the container is produced. The preceding object is preferably solved under the condition of the symbol being based on a predetermined coding. It is a further object that in the context of one of the preceding advantageous laminates or containers an adhesion strength of the decoration and/or the symbol is as high as possible. Therein, the adhesion strength may be relevant for a visual appearance of the decoration or the symbol, or for a health risk of a consumer of the foodstuff. It is a further object that in the context of one of the preceding advantageous laminates or containers a process for manufacturing this laminate or container bears an as little as possible risk of impairing a moisture barrier of the laminate or container. It is a further object that in the context of one of the preceding advantageous containers that a foodstuff can be stored as long as possible in the container with as little impairment of a taste of the foodstuff as possible.

It is a further object of the invention to provide a process for producing a laminate for the production of dimensionally stable foodstuff containers and/or for the production of such a foodstuff container having a decoration and a 2D-code, wherein the process is as flexible as possible with regard to the process stage in which the 2D-code is applied. Further, it is an object of the invention to provide a process for producing a laminate for the production of dimensionally stable foodstuff containers and/or for the production of such a foodstuff containers having a decoration and a 2D-code, wherein inks of the decoration and the 2D-code can as much as possible be chosen independently from each other. Further, it is an object to provide one of the preceding advantageous processes, wherein the process can be performed as fast as possible. Further, it is an object to provide one of the preceding advantageous processes, wherein an amount of basic material used for the process can be reduced. Therein, a preferred basic material is an ink.

A contribution to at least partial achievement of at least one of the above objects is made by the independent claims. The dependent claims provide preferred embodiments which contribute to at least partial achievement of at least one of the objects.

A contribution to the achievement of at least one of the objects of the invention is made by an embodiment 1 of a sheetlike composite 1, comprising as layers of a layer sequence in a direction from an outer surface of the sheetlike composite to an inner surface of the sheetlike composite
a) an outer polymer layer,
b) a carrier layer, and
c) a barrier layer;
   wherein the sheetlike composite comprises a first composite region and a second composite region; wherein in the first composite region the sheetlike composite further comprises a first colour application, superimposing the outer polymer layer on a side of the outer polymer layer which is facing away from the inner surface of the sheetlike composite; wherein in the second composite region the sheetlike composite further comprises a second colour application, superimposing the outer polymer layer on the side of the outer polymer layer which is facing away from the inner surface of the sheetlike composite; wherein the second colour application comprises a 2D-code.

The sheetlike composite according to the invention may be a pre-cut for the production of a single closed container. However, the sheetlike composite may alternatively be suitable for the production of a plurality of closed containers. In this case, the sheetlike composite is preferably at least partly present in form of a roll.

In an embodiment 2 according to the invention, the sheetlike composite 1 is configured according to the embodiment 1, wherein the 2D-code comprises a graphic representation of a sequence of bits.

In an embodiment 3 according to the invention, the sheetlike composite 1 is configured according to the embodiment 1 or 2, wherein the first colour application or the second colour application or both adjoins/adjoin the outer polymer layer.

In an embodiment 4 according to the invention, the sheetlike composite 1 is configured according to any of the preceding embodiments, wherein the second colour application is not superimposed by any layer of the sheetlike composite on a side of the second colour application which is facing away from the outer polymer layer. In particular, in the second composite region the second colour application is preferably an outermost layer of the sheetlike composite.

In an embodiment 5 according to the invention, the sheetlike composite 1 is configured according to any of the preceding embodiments, wherein the first colour application is not superimposed by any layer of the sheetlike composite on a side of the first colour application which is facing away from the outer polymer layer. In particular, in the first composite region the first colour application is preferably an outermost layer of the sheetlike composite.

In an embodiment 6 according to the invention, the sheetlike composite 1 is configured according to any of the preceding embodiments, wherein in at least a part of the first composite region the outer surface of the sheetlike composite has a first surface tension, wherein in the second composite region the outer surface of the sheetlike composite has a second surface tension, wherein the first surface tension is more than the second surface tension. Preferably, the first surface tension is more than the second surface tension by at least 0.5 dyne/cm, more preferably by at least 1 dyne/cm, more preferably by at least 2 dyne/cm, most preferably by at least 3 dyne/cm. In the at least part of the first composite region the first colour application preferably has a surface coverage in the range from 70 to 100%, more preferably from 80 to 100, more preferably from 90 to 100, most preferably from 95 to 100%, each based on a surface area of the at least part of the first composite region, wherein 100% is particularly preferred.

In an embodiment 7 according to the invention, the sheetlike composite 1 is configured according to the embodiment 6, wherein the first surface tension is in a range from 42 to 46 dyne/cm, preferably from 42.5 to 45.5 dyne/cm, more preferably from 43 to 45 dyne/cm.

In an embodiment 8 according to the invention, the sheetlike composite 1 is configured according to the embodiment 6 or 7, wherein the second surface tension is in a range from 37 to 41.5 dyne/cm, preferably from 38 to 41 dyne/cm, more preferably from 39 to 41 dyne/cm. Preferably, the second colour application has a surface coverage in the range from 10 to 95%, more preferably from 15 to 90%, most preferably from 20 to 85%, each based on a surface area of the second composite region.

In an embodiment 9 according to the invention, the sheetlike composite 1 is configured according to any of the preceding embodiments, wherein the 2D-code has a symbol contrast of at least 20%, preferably at least 40%, more preferably at least 55%, most preferably at least 70%.

In an embodiment 10 according to the invention, the sheetlike composite 1 is configured according to any of the preceding embodiments, wherein the first colour application comprises a first number of colourants of different colours, wherein the second colour application comprises a second number of colourants of different colours, wherein the first number is more than the second number. Preferably, the second number is not more than 4, more preferably not more than 3, more preferably not more than 2, most preferably the second number is 1. Further preferably, the first number is at least 4, more preferably at least 5, most preferably at least 6.

In an embodiment 11 according to the invention, the sheetlike composite 1 is configured according to any of the preceding embodiments, wherein the sheetlike composite further comprises a third composite region, wherein in the third composite region the outer polymer layer is not superimposed by any layer of the sheetlike composite on a side of the outer polymer layer which faces away from the carrier layer. In particular, in the third composite region the outer polymer layer is preferably an outermost layer of the sheetlike composite.

In an embodiment 12 according to the invention, the sheetlike composite 1 is configured according to the embodiment 11, wherein the third composite region separates the first composite region from the second composite region. Preferably, the third composite region frames the second composite region. Therein the third composite region preferably has a frame width in the range from 1 to 5 mm, more preferably from 2 to 4 mm.

In an embodiment 13 according to the invention, the sheetlike composite 1 is configured according to the embodiment 11 or 12, wherein in at least a part of the first composite region the outer surface of the sheetlike composite has a first surface tension, wherein in the third composite region the outer surface of the sheetlike composite has a third surface tension, wherein the first surface tension is more than the third surface tension. Preferably, the first surface tension is more than the third surface tension by at least 5 dyne/cm, more preferably by at least 6 dyne/cm, more preferably by at least 7 dyne/cm, more preferably by at least 8 dyne/cm, more preferably by at least 9 dyne/cm, more preferably by at least 10 dyne/cm, more preferably by at least 12 dyne/cm, most preferably by at least 14 dyne/cm. In the at least part of the first composite region the first colour application preferably has a surface coverage in the range from 70 to 100%, more preferably from 80 to 100, more preferably from 90 to 100, most preferably from 95 to 100%, each based on a surface area of the at least part of the first composite region, wherein 100% is particularly preferred.

In an embodiment 14 according to the invention, the sheetlike composite 1 is configured according to any of the embodiments 11 to 13, wherein in the second composite region the outer surface of the sheetlike composite has a second surface tension, wherein in the third composite region the outer surface of the sheetlike composite has a third surface tension, wherein the second surface tension is more than the third surface tension. Preferably, the second surface tension is more than the third surface tension by at least 0.5 dyne/cm, more preferably by at least 1 dyne/cm, more preferably by at least 2 dyne/cm, more preferably by at least 3 dyne/cm, more preferably by at least 4 dyne/cm, more preferably by at least 5 dyne/cm, more preferably by at least 6 dyne/cm, more preferably by at least 7 dyne/cm, more preferably by at least 8 dyne/cm, most preferably by at least 9 dyne/cm.

In an embodiment 15 according to the invention, the sheetlike composite 1 is configured according to the embodiment 13 or 14, wherein the third surface tension is in a range from 28 to 36.5 dyne/cm, preferably from 29 to 36.5 dyne/cm, more preferably from 30 to 36.5 dyne/cm, more preferably from 31 to 36.5 dyne/cm, more preferably from 32 to 36.5 dyne/cm, most preferably from 33 to 36 dyne/cm. In another preferred embodiment the third surface tension is in a range from 28 to 35 dyne/cm, preferably from 28 to 34 dyne/cm, more preferably from 28 to 33 dyne/cm, more preferably from 28 to 32 dyne/cm, most preferably from 29 to 31 dyne/cm.

In an embodiment 16 according to the invention, the sheetlike composite 1 is configured according to any of the preceding embodiments, wherein on the side of the outer polymer layer which faces away from the inner surface of the sheetlike composite the sheetlike composite is characterised by an L-value in the Lab colour space of at least 80, preferably at least 85, more preferably at least 90.

In an embodiment 17 according to the invention, the sheetlike composite 1 is configured according to any of the preceding embodiments, wherein the first composite region has a first surface area, wherein the second composite region has a second surface area, wherein the first surface area is more than the second surface area, preferably by at least 10% of the outer surface of the sheetlike composite, more preferably by at least 20% of the outer surface of the sheetlike composite, more preferably by at least 30% of the outer surface of the sheetlike composite, more preferably by at least 40% of the outer surface of the sheetlike composite, most preferably by at least 50% of the outer surface of the sheetlike composite.

In an embodiment 18 according to the invention, the sheetlike composite 1 is configured according to the embodiment 17 or 18, wherein the first composite region has a first surface area, wherein the third composite region has a third surface area, wherein the first surface area is more than the third surface area, preferably by at least 10% of the outer surface of the sheetlike composite, more preferably by at least 20% of the outer surface of the sheetlike composite, more preferably by at least 30% of the outer surface of the sheetlike composite, more preferably by at least 40% of the outer surface of the sheetlike composite, most preferably by at least 50% of the outer surface of the sheetlike composite.

In an embodiment 19 according to the invention, the sheetlike composite 1 is configured according to any of the embodiments 11 to 17, wherein the first surface area is in the range from 20 to 90%, preferably from 30 to 90%, more preferably from 40 to 85%, most preferably from 50 to 85%, in each case of the outer surface of the sheetlike composite.

In an embodiment 20 according to the invention, the sheetlike composite 1 is configured according to any of the embodiments 17 to 19, wherein the second surface area is in the range from 1 to 10%, preferably from 2 to 8%, more preferably from 2 to 5%, in each case of the outer surface of the sheetlike composite.

In an embodiment 21 according to the invention, the sheetlike composite 1 is configured according to any of the embodiments 18 to 20, wherein the third surface area is in the range from 1 to 10%, preferably from 2 to 8%, more preferably from 2 to 5%, in each case of the outer surface of the sheetlike composite.

In an embodiment 22 according to the invention, the sheetlike composite 1 is configured according to any of the preceding embodiments, wherein the second colour application comprises a crosslinked polymer. A preferred crosslinked polymer is a poly-addition product.

In an embodiment 23 according to the invention, the sheetlike composite 1 is configured according to any of the preceding embodiments, wherein the 2D-code has an axial non-uniformity of not more than 0.12, preferably not more than 0.1, more preferably not more than 0.08, most preferably not more than 0.06.

In an embodiment 24 according to the invention, the sheetlike composite 1 is configured according to any of the preceding embodiments, wherein the 2D-code has an unused error correction parameter of at least 0.25, preferably at least 0.37, more preferably at least 0.5, most preferably at least 0.62.

In an embodiment 25 according to the invention, the sheetlike composite 1 is configured according to any of the embodiments 2 to 24, wherein the sequence of bits comprises at least 50 bits, preferably at least 100 bits, more preferably at least 200 bits, more preferably at least 300 bits, more preferably at least 400 bits, more preferably at least 500 bits, even more preferably at least 1000 bits, more preferably at least 1500, still more preferably at least 2000 bits, more preferably at least 3000 bits, more preferably at least 5000, more preferably at least 10000 bits, more preferably at least 15000 bits, most preferably at least 20000 bits.

In an embodiment 26 according to the invention, the sheetlike composite 1 is configured according to any of the preceding embodiments, wherein the first colour application is a first print image, wherein the second colour application is a second print imaged, wherein the first print image is obtainable by a first printing method, wherein the second print image is obtainable by a second printing method, wherein the first printing method is different from the second printing method.

In an embodiment 27 according to the invention, the sheetlike composite 1 is configured according to the embodiment 26, wherein the first printing method comprises applying a first ink composition to a printing substrate, comprising the carrier layer, by contacting the printing substrate with a printing forme. A preferred printing forme is a printing plate or a printing cylinder or both. A preferred first printing method is one selected from the group consisting of intaglio printing, offset printing, gravure printing, rotogravure printing, flexographic printing, relief printing and flat printing or a combination of at least two thereof.

In an embodiment 28 according to the invention, the sheetlike composite 1 is configured according to the embodiment 26 or 27, wherein the second printing method comprises applying a second ink composition to a printing substrate, comprising the carrier layer, without contacting the printing substrate with a printing forme.

In an embodiment 29 according to the invention, the sheetlike composite 1 is configured according to any of the embodiments 26 to 28, wherein the second printing method is a digital printing method or a non-impact printing method or both. The digital printing method or the non-impact printing method (NIP) or both each do not comprise contacting a printing substrate with a printing forme. A preferred digital printing method is an inkjet printing. A preferred non-impact printing method is an inkjet printing.

In an embodiment 30 according to the invention, the sheetlike composite 1 is configured according to any of the preceding embodiments, wherein the layer sequence further comprises an inner polymer layer, wherein the inner polymer layer superimposes the barrier layer on a side of the barrier layer which is facing away from the carrier layer.

In an embodiment 31 according to the invention, the sheetlike composite 1 is configured according to the embodiment 30, wherein the inner polymer layer includes from 10 to 90 wt. -%, preferably from 25 to 90 wt. -%, more preferably from 30 to 80 wt. -%, in each case based on the total weight of the inner polymer layer, of a polymer produced by means of a metallocene catalyst. A preferred polymer produced by means of a metallocene catalyst is an mPE.

In an embodiment 32 according to the invention, the sheetlike composite 1 is configured according to the embodiment 30 or 31, wherein the inner polymer layer includes a polymer blend, wherein the polymer blend includes from 10 to 90 wt. -%, preferably from 25 to 90 wt. -%, more preferably from 30 to 80 wt.-%, of an mPE and at least 10 wt. -%, preferably at least 15 wt. -%, more preferably at least 20 wt. -%, of a further polymer, in each case based on the total weight of the polymer blend.

In an embodiment 33 according to the invention, the sheetlike composite 1 is configured according to any of the preceding embodiments, wherein the layer sequence further comprises an intermediate polymer layer, wherein the intermediate polymer layer is arranged between the carrier layer and the barrier layer.

In an embodiment 34 according to the invention, the sheetlike composite 1 is configured according to any of the preceding embodiments, wherein the carrier layer has at least one hole, wherein the hole is covered at least by the barrier layer and the outer polymer layer as hole-covering layers. The hole-covering layers are in each case the layers at least partially covering the at least one hole.

In an embodiment 35 according to the invention, the sheetlike composite 1 is configured according to any of the preceding embodiments, wherein the carrier layer includes, preferably consists of, one selected from the group consisting of paperboard, cardboard, and paper, or a combination of at least two thereof.

A contribution to the achievement of at least one of the objects of the invention is made by an embodiment 1 of a process, comprising as process steps
a) providing a sheetlike composite precursor, comprising as layers of a layer sequence in a direction from an outer surface of the sheetlike composite precursor to an inner surface of the sheetlike composite precursor
   i) an outer polymer layer,
   ii) a carrier layer, and
   iii)a barrier layer;
b) adapting a surface tension of the outer surface at least in a first composite precursor region to a first value;
c) applying a first ink composition onto the outer surface in the first composite precursor region;
d) adapting the surface tension of the outer surface at least in a second composite precursor region to a further value; and
e) applying a second ink composition onto the outer surface in the second composite precursor region;
   wherein the further value is more than the first value. Preferably, the further value is more than the first value by at least 0.5 dyne/cm, more preferably by at least 1 dyne/cm, more preferably by at least 1.5 dyne/cm, more preferably by at least 2 dyne/cm, most preferably by at least 3 dyne/cm. Preferably, the process comprises at least one further process step of applying at least one further ink composition to the outer surface in the first composite precursor region between the process steps c) and d). Therein, the process comprises preferably at least 1, more preferably at least 2, more preferably at least 3, more preferably at least 4, more preferably at least 5, most preferably at least 6, further process steps between the process steps c) and d), wherein each of these further process steps comprises applying a further ink composition to the outer surface in the first composite precursor region. Preferably the process step c) is performed within 24 hours, preferably within 12 hours, more preferably within 3 hours, more preferably within 1 hour, more preferably within 30 minutes, more preferably within 10 minutes, most preferably within 1 minute, in each case from the adapting of the surface tension to the first value in the process step b). Preferably the process step e) is performed within 24 hours, preferably within 12 hours, more preferably within 3 hours, more preferably within 1 hour, more preferably within 30 minutes, more preferably within 10 minutes, most preferably within 1 minute, in each case from the adapting of the surface tension to the further value in the process step d).

In an embodiment 2 according to the invention, the process is configured according to the embodiment 1, wherein the outer surface is a surface of the outer polymer layer.

In an embodiment 3 according to the invention, the process is configured according to the embodiment 1 or 2, wherein in the process step b) the applying is a printing of the first ink composition directly onto the outer surface in the first composite precursor region.

In an embodiment 4 according to the invention, the process is configured according to any of the embodiments 1 to 3, wherein in the process step e) the applying is a printing of the second ink composition directly onto the outer surface in the second composite precursor region.

In an embodiment 5 according to the invention, the process is configured according to any of the embodiments 1 to 4, wherein the first value is in the range from 36 to 42 dyne/cm, preferably from 37 to 42 dyne/cm, more preferably from 38 to 42 dyne/cm, more preferably from 39 to 42 dyne/cm, most preferably from 40 to 42 dyne/cm.

In an embodiment 6 according to the invention, the process is configured according to any of the embodiments 1 to 5, wherein the further value is in the range from 42.5 to 46 dyne/cm, preferably from 43 to 46 dyne/cm, more preferably from 43.5 to 46 dyne/cm, more preferably from 44 to 46 dyne/cm, most preferably from 44.5 to 46 dyne/cm.

In an embodiment 7 according to the invention, the process is configured according to any of the embodiments 1 to 6, wherein between the process steps c) and d) the process further comprises a hardening of the first ink composition, thereby obtaining a first colour application, wherein the process further comprises a process step
f) hardening of the second ink composition, thereby obtaining a second colour application,
   wherein the second colour application comprises a 2D-code.

In an embodiment 8 according to the invention, the process is configured according to the embodiment 7, wherein in the process step f) the hardening of the second ink composition comprises a crosslinking reaction. A preferred crosslinking reaction is a photo-initiated crosslinking reaction. Therefore, the process step f) preferably comprises irradiating the second ink composition with UV-light.

In an embodiment 9 according to the invention, the process is configured according to the embodiment 7 or 8, wherein the 2D-code comprises a graphic representation of a sequence of bits.

In an embodiment 10 according to the invention, the process is configured according to the embodiment 9, wherein the sequence of bits comprises at least 50 bits, preferably at least 100 bits, more preferably at least 200 bits, more preferably at least 300 bits, more preferably at least 400 bits, more preferably at least 500 bits, even more preferably at least 1000 bits, more preferably at least 1500, still more preferably at least 2000 bits, more preferably at least 3000 bits, more preferably at least 5000, more preferably at least 10000 bits, more preferably at least 15000 bits, most preferably at least 20000 bits.

In an embodiment 11 according to the invention, the process is configured according to any of the embodiments 7 to 10, wherein the 2D-code has a symbol contrast of at least 20%, preferably at least 40%, more preferably at least 55%, most preferably at least 70%.

In an embodiment 12 according to the invention, the process is configured according to any of the embodiments 7 to 11, wherein the 2D-code has an axial non-uniformity of not more than 0.12, preferably not more than 0.1, more preferably not more than 0.08, most preferably not more than 0.06.

In an embodiment 13 according to the invention, the process is configured according to any of the embodiments 7 to 12, wherein the 2D-code has an unused error correction parameter of at least 0.25, preferably at least 0.37, more preferably at least 0.5, most preferably at least 0.62.

In an embodiment 14 according to the invention, the process is configured according to any of the embodiments 1 to 13, wherein in the process step c) the applying is effected by a first printing method, wherein in the process step e) the applying is effected by a second printing method, wherein the first printing method is different from the second printing method.

In an embodiment 15 according to the invention, the process is configured according to the embodiment 14, wherein the first printing method comprises contacting the outer surface with a printing forme. A preferred printing forme is a printing plate or a printing cylinder or both. A preferred first printing method is one selected from the group consisting of intaglio printing, gravure printing, offset printing, rotogravure printing, flexographic printing, relief printing and flat printing or a combination of at least two thereof.

In an embodiment 16 according to the invention, the process is configured according to the embodiment 14 or 15, wherein the second printing method does not comprise a contacting of the outer surface with a printing forme.

In an embodiment 17 according to the invention, the process is configured according to any of the embodiments 14 to 16, wherein the second printing method is a digital printing method or a non-impact printing method or both.

In an embodiment 18 according to the invention, the process is configured according to any of the embodiments 1 to 17, wherein the adapting in the process step b) or d) or both comprises one selected from the group consisting of a flame treatment, a fluorinating, a plasma treatment and a corona treatment or a combination of at least two thereof, wherein a corona treatment is particularly preferred. Generally, the corona treatment is an electrochemical process for treating surfaces, preferably polymer surfaces. Preferably, the corona treatment comprises exposing the outer surface to an electrical high-voltage-discharge. Preferably, the electrical high-voltage-discharge is effected between a first and a further electrode. Therein, the first electrode is preferably a roller. In this context, a preferred roll is a metal roller, preferably having a polished roller surface. A preferred roller surface is made of steel or aluminium or both. Further preferably, the first electrode is grounded and the further electrode is not grounded; or the first electrode is not grounded and the further electrode is grounded. Preferably during the corona treatment the outer surface at least partially faces the first electrode, more preferably the roller surface. Even more preferably, during the corona treatment the outer surface is at least partially in physical contact the first electrode, more preferably with the roller surface. The electrode of the first electrode and the further electrode which is not grounded is preferably electrically connected to a high-frequency-generator, being configured for providing an AC voltage in the range from 10 to 20 kV, preferably having a frequency in the range from 10 to 60 kHz.

In an embodiment 19 according to the invention, the process is configured according to any of the embodiments 1 to 18, wherein in one selected from the group consisting of the process steps b) to e) or in a combination of at least two thereof the composite precursor is moved with a velocity in the range from 200 to 1000 m/min, preferably from 250 to 900 m/min, more preferably from 250 to 800 m/min, more preferably from 250 to 700 m/min, most preferably from 300 to 600 m/min. Preferably, the composite precursor is moved with a velocity in the range from 200 to 1000 m/min, preferably from 250 to 900 m/min, more preferably from 250 to 800 m/min, more preferably from 250 to 700 m/min, most preferably from 300 to 600 m/min, in all of the process steps b) to e), preferably also in the process step f).

In an embodiment 20 according to the invention, the process is configured according to any of the embodiments 1 to 54, wherein the sheetlike composite precursor further comprises a third composite precursor region, wherein in the third composite precursor region no composition is applied onto the outer surface. In particular, in the third composite region the outer polymer layer is preferably an outermost layer of the sheetlike composite.

In an embodiment 21 according to the invention, the process is configured according to the embodiment 20, wherein the third composite region separates the first composite region from the second composite region. Preferably, the third composite precursor region frames the second composite precursor region. Therein the third composite precursor region preferably has a frame width in the range from 1 to 5 mm, more preferably from 2 to 4 mm.

In an embodiment 22 according to the invention, the process is configured according to any of the embodiments 1 to 21, wherein in the process step a) the sheetlike composite precursor has an L-value in the Lab colour space of at least 80, preferably at least 85, more preferably at least 90, in each case on the outer surface.

In an embodiment 23 according to the invention, the process is configured according to any of the embodiments 1 to 57, wherein the first composite precursor region has a first surface area, wherein the second composite precursor region has a second surface area, wherein the first surface area is more than the second surface area, preferably by at least 10% of the outer surface of the sheetlike composite precursor, more preferably by at least 20% of the outer surface of the sheetlike composite precursor, more preferably by at least 30% of the outer surface of the sheetlike composite precursor, more preferably by at least 40% of the outer surface of the sheetlike composite precursor, most preferably by at least 50% of the outer surface of the sheetlike composite precursor.

In an embodiment 24 according to the invention, the process is configured according to any of the embodiments 20 to 23, wherein the first composite precursor region has a first surface area, wherein the third composite precursor region has a third surface area, wherein the first surface area is more than the third surface area, preferably by at least 10% of the outer surface of the sheetlike composite precursor, more preferably by at least 20% of the outer surface of the sheetlike composite precursor, more preferably by at least 30% of the outer surface of the sheetlike composite precursor, more preferably by at least 40% of the outer surface of the sheetlike composite precursor, most preferably by at least 50% of the outer surface of the sheetlike composite precursor.

In an embodiment 25 according to the invention, the process is configured according to the embodiment 23 or 24, wherein the first surface area is in the range from 20 to 90%, preferably from 30 to 90%, more preferably from 40 to 85%, most preferably from 50 to 85%, in each case of the outer surface of the sheetlike composite precursor.

In an embodiment 26 according to the invention, the process is configured according to any of the embodiments 23 to 25, wherein the second surface area is in the range from 1 to 10%, preferably from 2 to 8%, more preferably from 2 to 5%, in each case of the outer surface of the sheetlike composite precursor.

In an embodiment 27 according to the invention, the process is configured according to any of the embodiments 24 to 26, wherein the third surface area is in the range from 1 to 10%, preferably from 2 to 8%, more preferably from 2 to 5%, in each case of the outer surface of the sheetlike composite precursor.

In an embodiment 28 according to the invention, the process is configured according to any of the embodiments 1 to 27, wherein the layer sequence further comprises an inner polymer layer, wherein the inner polymer layer superimposes the barrier layer on a side of the barrier layer which is facing away from the carrier layer.

In an embodiment 29 according to the invention, the process is configured according to any of the embodiments 1 to 57, wherein the inner polymer layer includes from 10 to 90 wt. -%, preferably from 25 to 90 wt. -%, more preferably from 30 to 80 wt. -%, in each case based on the total weight of the inner polymer layer, of a polymer produced by means of a metallocene catalyst. A preferred polymer produced by means of a metallocene catalyst is an mPE.

In an embodiment 30 according to the invention, the process is configured according to the embodiment 28 or 29, wherein the inner polymer layer includes a polymer blend, wherein the polymer blend includes from 10 to 90 wt. -%, preferably from 25 to 90 wt. -%, more preferably from 30 to 80 wt.-%, of an mPE and at least 10 wt. -%, preferably at least 15 wt. -%, more preferably at least 20 wt. -%, of a further polymer, in each case based on the total weight of the polymer blend.

In an embodiment 31 according to the invention, the process is configured according to any of the embodiments 1 to 30, wherein the layer sequence further comprises an intermediate polymer layer, wherein the intermediate polymer layer is arranged between the carrier layer and the barrier layer.

In an embodiment 32 according to the invention, the process is configured according to any of the embodiments 1 to 31, wherein the carrier layer has at least one hole, wherein the hole is covered at least by the barrier layer and the outer polymer layer as hole-covering layers.

In an embodiment 33 according to the invention, the process is configured according to any of the embodiments 1 to 32, wherein the carrier layer includes, preferably consists of, one selected from the group consisting of paperboard, cardboard, and paper, or a combination of at least two thereof.

A contribution to the achievement of at least one of the objects of the invention is made by an embodiment 1 of a sheetlike composite 2, obtainable by the process according to any of its above embodiments 1 to 33. Preferably, the sheetlike composite 2 is configured according to any of the embodiments 1 to 35 to the sheetlike composite 1.

A contribution to the achievement of at least one of the objects of the invention is made by an embodiment 1 of a container precursor, at least comprising a pre-cut of the sheetlike composite 1 according to any of its embodiments 1 to 35, or of the sheetlike composite 2 according to its embodiment 1. A preferred pre-cut of the sheetlike composite is configured for the production of a single closed container. However, the container precursor can also comprise the sheetlike composite in a form which is suitable for the production of a plurality of closed containers. Further, if the sheetlike composite is a pre-cut for the production of a single closed container, the container precursor preferably comprises the sheetlike composite as a whole.

A contribution to the achievement of at least one of the objects of the invention is made by an embodiment 1 of a closed container, at least comprising a pre-cut of the sheetlike composite 1 according to any of its embodiments 1 to 35, or of the sheetlike composite 2 according to its embodiment 1. A preferred pre-cut of the sheetlike composite is configured for the production of a single closed container. Further, if the sheetlike composite is a pre-cut for the production of a single closed container, the closed container preferably comprises the sheetlike composite as a whole.

A contribution to the achievement of at least one of the objects of the invention is made by an embodiment 1 of a use 1 of the sheetlike composite 1 according to any of its embodiments 1 to 35, or of the sheetlike composite 2 according to its embodiment 1, in each case for producing a foodstuff container.

A contribution to the achievement of at least one of the objects of the invention is made by an embodiment 1 of a use 2 of an inkjet printer for printing a 2D-code directly onto an outer polymer layer of a sheetlike composite, wherein the sheetlike composite comprises as layers of a layer sequence in a direction from an outer surface of the sheetlike composite to an inner surface of the sheetlike composite
a) the outer polymer layer,
b) a carrier layer, and
c) a barrier layer.

In an embodiment 2 according to the invention, the use 2 is configured according to its embodiment 1, wherein the sheetlike composite comprises a first composite region and a second composite region, wherein in the first composite region the sheetlike composite further comprises a first colour application, adjoining the outer polymer layer on a side of the outer polymer layer which is facing away from the inner surface of the sheetlike composite, wherein the 2D-code is printed directly onto the outer polymer in the second composite region.

Features which are described to be preferred in the context of a category of the invention, in particular according to the sheetlike composite of the invention or the process according to the invention, are as well preferred in further embodiments of the further categories of the invention.

### Composite Regions

Generally, the first, second and third composite region refer to distinct regions which each extend in a sheet plane of the sheetlike composite. Analogously, the first, second and third composite precursor region refer to distinct regions which each extend in a sheet plane of the sheetlike composite precursor. Therein, the plane may be flat or curved. For example, the plane may be curved if the sheetlike composite or the sheetlike composite precursor is rolled up to form a roll. Preferably, the first composite region or the second composite region or both is a continuous region. Preferably, the first composite region and the second composite region adjoin each other along a continuous border line. Preferably, the first composite region does not comprise any part of the second colour application. Further preferably, the second composite region does not comprise any part of the first colour application. Preferably, the first composite precursor region or the second composite precursor region or both is a continuous region. Preferably, the first composite precursor region and the second composite precursor region adjoin each other along a continuous border line. Further, the third composite region or the third composite precursor region or both is a continuous region. Preferably, the third composite region is positioned between the first composite region and the second composite region. Preferably, the third composite precursor region is positioned between the first composite precursor region and the second composite precursor region.

### 2D-Code

The 2D-code according to the invention may be any 2D-code which the skilled person may consider appropriate in the context of the invention. Preferably, the 2D-code comprises a plurality of graphic elements and a plurality of gaps between these graphic elements. Preferred graphic elements are lines, preferably straight lines; rectangles, preferably squares; circles; and dots; and combinations of these. Further preferably, data may be encoded into the 2D-code along two axes of a 3-dimensional system of coordinates, hence in 2 dimensions which span an a plane. These two axes of the system of coordinates are also referred to as 2 dimensions. In this context the 2D-code is preferably a 2-dimensional reproduction of data in form of the graphic elements, wherein these graphic elements are arranged in a predetermined 2-dimensional area, thereby encoding the data in 2 dimensions. Therein, pieces of information which are stored in the 2 dimensions are preferably independent from each other. In this context preferred systems of coordinates are a Cartesian system of coordinates and a polar system of coordinates. A preferred 2D-code is machine-readable, wherein preferably the 2D-code is readable by an optoelectronic sensor. Preferably, the 2D-code is readable by a 2D-code reader. Therein, the 2D-code reader may be a device, having an optoelectronic sensor; or a scanner software; or both. A preferred optoelectronic sensor is a laser scanner or a CCD-camera, for example of a smartphone.

A preferred 2D-code is one selected from the group consisting of a matrix code, a 2D-barcode and a dot-code or a combination of at least two thereof. Therein, a matrix code is particularly preferred. A preferred 2D-barcode comprises a plurality of stacked 1D-barcodes. Further preferred 2D-barcodes are Codablock, Code 49, Code 16k and PDF417. Preferred matrix codes are Aztec code, Code 1, ColorCode, Color Construct Code, CrontoSign, CyberCode, Data Matrix, DataGlyphs, Datastrip Code, EZcode, High Capacity Color Barcode, Hax Xin Barcode, HieCode, InterCode, MaxiCode, NexCode, Qode, QR code, ShotCode, SPARQCode, VOICEYE, wherein QR code and SPARQCode are preferred, wherein QR code is particularly preferred. Preferred dot-codes are Dot Code A, Snowflake ode and BeeTagg. A further preferred 2D-code has an area of not more than 40 cm², preferably not more than 30 cm², more preferably not more than 25 cm², even more preferably not more than 20 cm², more preferably not more than 15 cm², more preferably not more than 10 cm², still more preferably not more than 8 cm², most preferably not more than 5 cm².

### Colour Application

Generally, a colour application is a solid material on a surface, wherein the solid material comprises at least one colourant. According to DIN 55943:2001-10, colourant is the collective term for all colouring substances, especially for dyes and pigments. A preferred colourant is a pigment. A preferred pigment is an inorganic pigment or an organic pigment or both, wherein the organic pigment is particularly preferred. Pigments that are notable in connection with the invention are especially the pigments mentioned in DIN 55943:2001-10 and those mentioned in “Industrial Organic Pigments, Third Edition” (Willy Herbst, Klaus Hunger Copyright © 2004 WILEY-VCH Verlag GmbH & Co. KGaA, Weinheim ISBN: 3-527-30576-9). However, other pigments may be considered as well. For example, the following are further notable suitable pigments:
i. red or magenta pigments: pigment red 3, 5, 19, 22, 31, 38, 43, 48:1, 48:2, 48:3, 48:4, 48:5, 49:1, 53:1, 57:1, 57:2, 58:4, 63:1, 81, 81:1, 81:2, 81:3, 81:4, 88, 104, 108, 112, 122, 123, 144, 146, 149, 166, 168, 169, 170, 177, 178, 179, 184, 185, 208, 216, 226, 257, pigment violet 3, 19, 23, 29, 30, 37, 50 and 88;
ii. blue or cyan pigments: pigment blue 1, 15, 15:1, 15:2, 15:3, 15:4, 15:6, 16, 17-1, 22, 27, 28, 29, 36 and 60;
iii. green pigments: pigment green 7, 26, 36 and 50;
iv. yellow pigments: pigment yellow 1, 3, 12, 13, 14, 17, 34, 35, 37, 55, 74, 81, 83, 93, 94, 95, 97, 108, 109, 110, 128, 137, 138, 139, 153, 154, 155, 157, 166, 167, 168, 177, 180, 185 and 193 and
v. white pigments: pigment white 6, 18 and 21.

The first colour application preferably comprises one or more colourants in a total proportion of 1 to 30% by weight, preferably 3 to 27% by weight in total, more preferably of 5 to 24% by weight in total, most preferably of 10 to 20% by weight in total, based in each case on the weight of first colour application.

The first colour application preferably comprises at least 2 colourants, more preferably at least 3 colourants, more preferably at least 4 colourants, even more preferably at least 5, most preferably at least 6 colourants. In a preferred embodiment, the first colour application comprises exactly 4 colourants or exactly 6 colourants. A preferred first colour application is obtainable from the first ink composition, or from the first ink composition and one or more further ink compositions, each as described herein in the context of the process according to the invention, by hardening these ink composition(s). Furthermore, a preferred first colour application is a decoration or comprises a plurality of decorations, preferably a plurality of identical decorations. A preferred decoration is a decoration of a container, preferably a foodstuff container, to be produced from the sheetlike composite. A preferred decoration comprises information for identification and/or promotion of a foodstuff, preferably the foodstuff to be stored in a container, to be produced from the sheetlike composite. Further preferably, the first decoration comprises a polyvinyl acetal in a proportion of at least 40% by weight, preferably at least 45% by weight, more preferably at least 50% by weight, more preferably at least 55% by weight, most preferably at least 60% by weight, based in each case on the weight of the first colour application.

The second colour preferably comprises at least 1 colourant, or at least 2 colourants, or at least 3 colourants, or at least 4. In a particularly preferred embodiment, the second colour application comprises exactly 1 colourant, which is preferably a black pigment. An example of a black pigment is soot. A preferred second colour application is obtainable from the second ink composition, as described herein in the context of the process according to the invention, by hardening this second ink composition. Furthermore, a preferred second colour application forms a plurality of graphic elements of the 2D-code. Preferably, the second colour application comprises a crosslinked polymer, which is preferably a poly-addition product.

Polyvinyl Acetal Polyvinyl acetals are thermoplastics which are prepared by reaction of polyvinyl alcohol with aldehydes or ketones. According to the aldehyde used, for example formaldehyde, acetaldehyde or butyraldehyde, a distinction is made between various polyvinyl acetals. Preferred polyvinyl acetals are polyvinyl formal and polyvinyl butyral. A particularly preferred polyvinyl acetal is polyvinyl butyral (PVB).

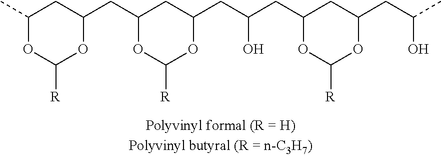

### Poly-Addition Product

As poly-addition product of the second colour application, all those poly-addition products known to the person skilled in the art which to him seem to be suitable for the sheetlike composite according to the invention come into consideration. In contrast to chain polymerisates, monomers of the poly-addition products are able to react with each other to form di-, tri- or oligomers without the need for an initiator which, as with radical polymerisation, starts a reaction of a monomer which then successively reacts with other monomers. The di, tri- or oligomers which are formed at the start of the poly-addition are additionally able to react with each other to form larger units. Typical poly-addition products are polyamides, polycarbonates, polyesters, polyphenylenoxides, polysulphones, polyepoxides or polyurethanes or a combination of at least two thereof, particularly preferred poly-addition products being those composed at least 50% by weight, preferably at least 70% by weight and particularly preferably 90% by weight of polyurethane, in each case based on the poly-addition product. It is further preferred that the second colour application comprises at least 50% by weight, preferably at least 70% by weight and at particularly preferably at least 90% by weight, in each case based on the weight of the second colour application, of the poly-addition product. However, the second colour application generally comprises no more than 99% by weight of the poly-addition product in order to be able to comprise further materials as well.

### Ink Compositions

The ink compositions referred to in the context of the process according to the invention are preferably liquids. Preferred liquids are solutions or slurries or both. The first ink composition and each further ink composition preferably comprise a polyvinyl acetal, a solvent and a colourant. Therein, the first ink composition and each further ink composition each comprise preferably 1 to 30% by weight, more preferably 2 to 25% by weight, most preferably 3 to 20% by weight, of the polyvinyl acetal, in each case based on the weight of the ink composition. Further, the first ink composition and each further ink composition each comprise preferably 1 to 30% by weight, more preferably 2 to 25% by weight, most preferably 3 to 20% by weight, of the colourant, in each case based on the weight of the ink composition. Moreover, the first ink composition and each further ink composition each comprise preferably 10 to 90% by weight, more preferably 15 to 85% by weight, most preferably 20 to 80% by weight, of the solvent, in each case based on the weight of the ink composition. Preferred first ink compositions or preferred further ink compositions or both are selected from the group consisting of an intaglio printing ink, an offset printing ink a gravure printing ink, a rotogravure printing ink, a flexographic printing ink, a relief printing ink and a flat printing ink or a combination of at least two thereof.

The second ink composition preferably comprises at least one, preferably at least 2, more preferably at least 5, more preferably at least 10, more preferably at least 15, most preferably at least 20, crosslinking initiators; at least 2 components which can react with each other, wherein this reaction can preferably be started by at least one of the preceding crosslink initiator; a solvent; and a colourant. Preferably, the at least two components are suitable for forming a poly-addition product, preferably a polyurethane. At least one of the crosslinking initiators, preferably a combination of at least two, more preferably all, of the crosslinking initiators, is suitable for initiating the reaction of the at least two components, wherein the reaction is preferably a crosslinking reaction. A preferred crosslinking initiator is a photo-initiator, which may preferably be activated by irradiation with UV-light.

Further, it is preferred in the process according to the invention that the first, further and/or second ink composition has a viscosity in the range from 0.05 to 0.3 Pas and preferably in a range from 0.1 to 0.2 Pas during applying this ink composition onto the outer surface.

### Solvent

Materials with a melting point lower than 10° C. are considered as solvent. In principle, all solvents known to the person skilled in the art and which are suitable for the process according to the invention come into consideration. Polar solvents are preferred. Here, protic and aprotic solvents are suitable, of which aprotic polar solvents are preferred, of which esters and ketones, acetone for example, are particularly preferred. As ester, above all ethylacetate, N-propylacetate or methoxypropylacetate come into consideration. A preferred solvent is ethanol. Ethanol particularly preferred as solvent for the first or any further ink composition.

### Outer Surface

The outer surface of the sheetlike composite is a surface of the sheetlike composite which is intended to be in contact with the environment of the container to be produced from the sheetlike composite. This does not mean that, in individual regions of the container, outer surfaces of various regions of the composite are not folded against one another or joined to one another, for example sealed to one another.

### Inner Surface

The inner surface of the sheetlike composite is a surface of the sheetlike composite which is intended to be in contact with the contents of the container, preferably a foodstuff, in a container to be produced from the sheetlike composite.

### Print Forme

The print forme may also be referred to as print image storage means or printing form or both. A preferred print image storage means is one selected from the group consisting of a print cylinder, a print roller and a print plate or a combination of at least two thereof. A preferred print cylinder is an intaglio print cylinder or a flexographic print cylinder or both. A preferred print roller is an intaglio print roller or a flexographic print roller or both.

### Layers

Unless otherwise stated, the layers in a layer sequence can follow one another indirectly, i.e. with one or at least two intermediate layers, or directly, i.e. without intermediate layer. This is in particular the case with wording wherein there is a layer superimposed on another layer. Wording wherein a layer sequence includes a list of layers means that at least the stated layers are present in the stated sequence. This wording does not necessarily mean that these layers follow one another directly. Wording wherein two layers are adjoin one another means that these two layers follow one another directly and therefore without intermediate layer.

### Carrier Layer

Material used as carrier layer can be any suitable material which is known to the person skilled in the art for this purpose and which has strength and stiffness sufficient to provide the container with stability to such an extent that the container in essence retains its shape in the presence of its contents. This document also uses the term dimensionally stable to describe a container of this type. In particular, bags and containers made of foils without carrier layer are not dimensionally stable. Preferred materials for the carrier layer are not only several plastics but also plant-based fibre materials, in particular chemical pulps, preferably glued, bleached and/or unbleached chemical pulps, particular preference being given here to paper and paperboard. The weight per unit area of the carrier layer is preferably in the range from 120 to 450 g/m², particularly preferably in the range from 130 to 400 g/m² and most preferably in the range from 150 to 380 g/m². A preferred paperboard generally has a single- or multilayer structure and can have been coated on one or both sides with one or more covering layers. The residual moisture content of a preferred paperboard is moreover less than 20% by weight, preferably from 2 to 15% by weight and particularly preferably from 4 to 10% by weight, based on the total weight of the paperboard. A particularly preferred paperboard has a multilayer structure. It is further preferable that the paperboard has, on the surface facing towards the environment, at least one, but particularly preferably at least two, sublayers of a covering layer known to the person skilled in the art as “paper coating”. The Scott Bond value of a preferred paperboard is moreover in the range from 100 to 360 J/m², preferably from 120 to 350 J/m² and particularly preferably from 135 to 310 J/m². Use of the abovementioned ranges allows provision of a composite from which it is easily possible to fold a highly leakproof container with narrow tolerances. A preferred carrier layer includes on at least one surface, preferably on each of two mutually opposite surfaces, a covering layer. Except where this is expressly excluded, it is preferable that each carrier layer includes a covering layer on each surface. It is preferable that the carrier layer is of one-piece design.

The carrier layer has a bending resistance which can be determined according to the standard ISO 2493:2010 using a bending measurement device. As a bending measurement device an L&W Bending Tester—code 160 of Lorentzen & Wettre, Sweden has been applied in making the present invention. The bending resistance is determined by deflecting the sample by 15°. In a first direction, the carrier layer preferably has a bending resistance in the range from 80 to 550 mN. In the case of a carrier layer having a plurality of fibres, the first direction is preferably a direction of orientation of the fibres. In the field of paper and cardboard making this direction of orientation of fibres is also known as running direction. In a second direction which is perpendicular to the first direction, a carrier layer having a plurality of fibres further preferably has bending resistance in the range from 20 to 300 mN. Samples used to determine the preceding bending resistances with the bending measurement device mentioned above have a width of 38 mm and a clamping length of 50 mm. A preferred sheetlike composite having the carrier layer is characterised by a bending resistance in the first direction in the range from 100 to 700 mN. Further preferably, this sheetlike composite has a bending resistance in the second direction in the range from 50 to 500 mN. Therein, the bending resistance measurements of the sheetlike composite have been performed using the same measuring device as mentioned above for the carrier layer. Furthermore, measurement samples of the sheetlike composite also had a width of 38 mm and a clamping length of 50 mm.

### Barrier Layer

Material used as barrier layer can be any material which is known for this purpose to the person skilled in the art and which exhibits adequate barrier action in particular in relation to oxygen. It is preferable that the barrier layer is selected from
a. a plastics barrier layer;
b. a metal layer;
c. a metal oxide layer; or
d. a combination of at least two of a. to c.

It is preferable that the barrier layer is of one-piece design.

If, according to alternative a., a barrier layer is a plastics barrier layer, this preferably includes at least 70% by weight, particularly at least 80% by weight and most preferably at least 95% by weight, of at least one plastic which is known for this purpose to the person skilled in the art, in particular on account of aroma properties or, respectively, gas-barrier properties that are suitable for packaging containers. Plastics, in particular thermoplastics, that can be used here are N- or O-containing plastics, either as such or else in mixtures of two or more. A melting point of the plastics barrier layer in the range from more than 155 to 300° C., preferably in the range from 160 to 280° C. and particularly preferably in the range from 170 to 270° C. can prove advantageous according to the invention. A preferred electrically insulating barrier layer is a plastics barrier layer.

It is further preferable that the weight per unit area of the plastics barrier layer is in the range from 2 to 120 g/m², preferably in the range from 3 to 60 g/m², particularly preferably in the range from 4 to 40 g/m² and with further preference from 6 to 30g/m². It is further preferable that the plastics barrier layer can be obtained from melts, for example via extrusion, in particular layer extrusion. It is further preferable that the plastics barrier layer can be introduced into the sheetlike composite by way of lamination. Preference is given here to incorporation of a foil into the sheetlike composite. According to another embodiment it is also possible to select plastics barrier layers which can be obtained via deposition from a solution or dispersion of plastics.

Suitable polymers are preferably those whose weight-average molar mass, determined by gel permeation chromatography (GPC) using light scattering, is in the range from 3.10³ to 1.10⁷ g/mol, preferably in the range from 5.10³ to 1.10⁶ g/mol and particularly preferably in the range from 6.10³ to 1.10⁵ g/mol. Suitable polymers that in particular can be used are polyamide (PA) or polyethylene vinyl alcohol (EVOH) or a mixture thereof.

Among the polyamides, it is possible to use any of the PAs that appear to a person skilled in the art to be suitable for the inventive use. Particular mention should be made here of PA 6, PA 6.6, PA 6.10, PA 6.12, PA 11 or PA 12 or a mixture of at least two thereof, particular preference being given here to PA 6 and PA 6.6, and further preference being given here to PA 6. PA 6 is obtainable commercially by way of example with the trademark Akulon®, Durethan® and Ultramid®. Other suitable materials are amorphous polyam ides such as MXD6, Grivory®, and also Selar® PA. It is further preferable that the density of the PA is in the range from 1.01 to 1.40 g/cm³, preferably in the range from 1.05 to 1.30 g/cm³ and particularly preferably in the range from 1.08 to 1.25 g/cm³. It is further preferable that the viscosity number of the PA is in the range from 130 to 185 ml/g and preferably in the range from 140 to 180 ml/g.

EVOH that can be used is any of the EVOHs that appear to the person skilled in the art to be suitable for the inventive use. Examples here are obtainable commercially inter alia with the trademark EVAL™ from EVAL Europe NV, Belgium in a plurality of different embodiments, examples being the grades EVAL™ F104B and EVAL™ LR171B. Preferred EVOHs have at least one, two, a plurality of, or all of, the following properties:
ethylene content in a range from 20 to 60 mol %, preferably from 25 to 45 mol %;
density in the range from 1.0 to 1.4 g/cm³, preferably from 1.1 to 1.3 g/cm³;
melting point in the range from above 155 to 235° C., preferably from 165 to 225° C.;
MFR (210° C./2.16 kg if T_{M(EVOH)}<230° C.; 230° C./2.16 kg, if 210° C.<T_{M(EVOH)}<230° C.) in the range from 1 to 25 g/10 min, preferably from 2 to 20 g/10 min;
oxygen permeation rate in the range from 0.05 to 3.2 cm³·20 pm/m²·day·atm, preferably in the range from 0.1 to 1 cm³·20 pm/m²·day·atm.

According to alternative b. the barrier layer is a metal layer. A suitable metal layer is in principle any of the layers using metals which are known to the person skilled in the art and which can provide high impermeability to light and to oxygen. According to a preferred embodiment the metal layer can take the form of a film or of a deposited layer, e.g. after a physical gas-phase deposition process. It is preferable that the metal layer is an uninterrupted layer. According to another preferred embodiment, the thickness of the metal layer is in the range from 3 to 20 μm, preferably in the range from 3.5 to 12 μm and particularly preferably in the range from 4 to 10 μm.

Metals preferably selected are aluminium, iron or copper. A preferred iron layer can be a steel layer, e.g. in the form of a foil. It is further preferable that the metal layer is a layer using aluminium. The aluminium layer can advantageously consist of an aluminium alloy, for example AlFeMn, AlFe1.5Mn, AlFeSi or AlFeSiMn. Purity is usually 97.5% or higher, preferably 98.5% or higher, based in each case on the entire aluminium layer. In a particular embodiment the metal layer consists of an aluminium foil. The extensibility of suitable aluminium foils is more than 1%, preferably more than 1.3% and particularly preferably more than 1.5%, and their tensile strength is more than 30 N/mm², preferably more than 40 N/mm² and particularly preferably more than 50 N/mm². Suitable aluminium foils exhibit a droplet size of more than 3 mm in the pipette test, preferably more than 4 mm and particularly preferably more than 5 mm. Suitable alloys for the production of aluminium layers or aluminium foils are obtainable commercially as EN AW 1200, EN AW 8079 or EN AW 8111 from Hydro Aluminium Deutschland GmbH or Amcor Flexibles Singen GmbH. A preferred electrically conductive barrier layer is a metal barrier layer, particularly preferably an aluminium barrier layer.

When a metal foil is used as barrier layer, there can be an adhesion-promoter layer provided on one or both sides of the metal foil between the metal foil and the closest polymer layer. According to a particular embodiment of the container of the invention, however, there is no adhesion-promoter layer provided on any side of the metal foil between the metal foil and the closest polymer layer.

It is further preferable to select a metal oxide layer as barrier layer according to alternative c. Metal oxide layers that can be used are any of the metal oxide layers that are familiar to the person skilled in the art and that appear suitable for achieving a barrier effect in relation to light, water vapour and/or gas. In particular, preference is given to metal oxide layers based on the abovementioned metals aluminium, iron or copper and also to metal oxide layers based on compounds of titanium or silicon oxide. A metal oxide layer is produced by way of example via deposition of a metal oxide from a vapour onto a plastics layer, for example an oriented polypropylene film. A preferred process for this is physical gas-phase deposition.

According to another preferred embodiment the metal layer or the metal oxide layer can take the form of a layer composite made of one or more plastics layers with a metal layer. This type of layer can be obtained by way of example via vapour deposition of a metal onto a plastics layer, for example an oriented polypropylene film. A preferred process for this is physical gas-phase deposition.

### Polymer Layers

The following specifications are preferably valid for any of the inner polymer layer, the outer polymer layer and the intermediate polymer layer, or for combinations of at least two of those. However, the sheetlike composite and the sheetlike composite precursor may comprise further polymer layers for which the following specifications are also valid. The polymer layer can comprise further constituents. It is preferable that these polymer layers are introduced or, respectively, applied into the layer sequence in an extrusion process. The further constituents of the polymer layers are preferably constituents which do not adversely affect the behaviour of the polymer melt when applied as layer. The further constituents can by way of example be inorganic compounds, such as metal salts or further plastics, for example further thermoplastics. However, it is also conceivable that the further constituents are fillers or pigments, for example carbon black or metal oxides. Suitable thermoplastics that can be used for the further constituents are in particular those that are easily processable by virtue of good extrusion properties. Materials suitable in this context are polymers obtained via chain polymerisation, in particular polyesters or polyolefins, particular preference being given here to cyclic olefin copolymers (COC), and polycyclic olefin copolymers (POC), and in particular polyethylene and polypropylene, and very particular preference being given here to polyethylene. Among the polyethylenes, preference is given to HDPE, MDPE, LDPE, LLDPE, VLDPE and PE, and also to mixtures of at least two thereof. It is also possible to use mixtures of at least two thermoplastics. Another preferred polyolefin is an m-polyolefin. The melt flow rate (MFR) of suitable polymer layers is in the range from 1 to 25 g/10 min, preferably in the range from 2 to 20 g/10 min and particularly preferably in the range from 2.5 to 15 g/10 min, their density being in the range from 0.890 g/cm³ to 0.980 g/cm³, preferably in the range from 0.895 g/cm³to 0.975 g/cm³, and more preferably in the range from 0.900 g/cm³ to 0.970 g/cm³; or in the range from 0.910 g/cm³to 0.935 g/cm³, preferably in the range from 0.912 g/cm³ to 0.932 g/cm³, and more preferably in the range from 0.915 g/cm³ to 0.930 g/cm³. The polymer layers preferably have at least one melting point in the range from 80 to 155° C., with preference in the range from 90 to 145° C. and particularly preferably in the range from 95 to 135° C. A preferred polymer layer is a polyolefin layer, preferably a polyethylene layer or a polypropylene layer or both.

m-Polyolefin

An m-polyolefin is a polyolefin produced by means of a metallocene catalyst. A metallocene is an organometallic compound in which there is a central metal atom arranged between two organic ligands, for example cyclopentadienyl ligands. A preferred m-polyolefin is an m-polyethylene (mPE) or an m-polypropylene or both. A further preferred m-polyethylene is one selected from the group consisting of an mLDPE, an mLLDPE, and an mHDPE, or a combination of at least two thereof.

### Inner Polymer Layer

In a preferred embodiment the inner polymer layer includes from 10 to 50% by weight, preferably 15 to 45% by weight, more preferably from 20 to 40% by weight, most preferably from 25 to 35% by weight, based in each case on the total weight of the inner polymer layer, of a polymer produced by means of a metallocene catalyst. In another preferred embodiment the inner polymer layer includes from 20 to 90% by weight, preferably from 30 to 90% by weight, more preferably from 40 to 90% by weight, more preferably from 50 to 90% by weight, more preferably from 60 to 90% by weight, most preferably from 70 to 85% by weight, based in each case on the total weight of the inner polymer layer, of a polymer produced by means of a metallocene catalyst.

It is preferable that the inner polymer layer consists of the polymer blend including an mPE and a further polymer. A preferred further polymer is one selected of a PE, am LDPE and an LLDPE or a combination of those. In a preferred embodiment the polymer blend includes from 10 to 50% by weight, preferably from 15 to 45% by weight, more preferably from 20 to 40% by weight, most preferably from 25 to 35% by weight, of an mPE and at least 50% by weight, preferably at least 55% by weight, more preferably at least 60% by weight, most preferably at least 65% by weight, of a further polymer, based in each case on the total weight of the polymer blend. In another preferred embodiment the polymer blend includes from 20 to 90% by weight, preferably from 30 to 90% by weight, more preferably from 40 to 90% by weight, more preferably from 50 to 90% by weight, more preferably from 60 to 90% by weight, most preferably from 70 to 85% by weight, of an mPE and at least 10% by weight, preferably at least 15% by weight, of a further polymer, based in each case on the total weight of the polymer blend. The proportions of mPE and of further polymer in the polymer blend here are preferably combined in such a way that the sum of the proportions is 100% by weight. In each case the preferred proportions of mPE and of further polymer in the polymer blend are combined in such a way that the sum of the proportions is not more than 100% by weight. It is preferable that the inner surface of the sheetlike composite is a surface of the inner polymer layer that faces away from the barrier layer. The innersurface of the sheetlike composite here preferably is the surface which in a container to be produced from the sheetlike composite faces predominantly inwards, i.e. in particular is in direct contact with a food contained in the container.

### Outer Polymer Layer

The outer polymer layer preferably comprises a polyethylene or a polypropylene or both. Here, preferred polyethylenes are LDPE and HDPE or mixtures of those. A preferred outer polymer layer comprises at least 50 & by weight, preferably at least 60% by weight, more preferably 70% by weight, more preferably 90% by weight, most preferably 90% by weight, in each case based on the weight of the outer polymer layer, of an LDPE.

### Melting Points

A preferred m-polyolefin is characterised by at least one first melting point and one second melting point. It is preferable that the m-polyolefin is characterised by a third melting point in addition to the first and the second melting point. A preferred first melting point is in the range from 84 to 108° C., preferably from 89 to 103° C., more preferably from 94 to 98° C. A preferred further melting point is in the range from 100 to 124° C., preferably from 105 to 119° C., more preferably from 110 to 114° C.

### Adhesion/Adhesion-Promoter Layer

There can be an adhesion-promoter layer located between layers of the sheetlike composite which do not adjoin each other. In particular, there can be an adhesion-promoter layer located between the barrier layer and the inner polymer layer or the carrier layer and the barrier layer. Plastics which can be used as adhesion promoters in an adhesion-promoter layer are any of those which, by virtue of functionalisation by means of suitable functional groups, are suitable to produce a secure bond via formation of ionic bonds or covalent bonds to a surface of a respective adjacent layer. The materials are preferably functionalised polyolefins obtained via copolymerisation of ethylene with acrylic acids such as acrylic acid or methacrylic acid, crotonic acid, acrylates, acrylate derivatives or carboxylic anhydrides containing double bonds, for example maleic anhydride, or at least two thereof. Among these, preference is given to polyethylene-maleic anhydride graft polymers (EMAH), ethylene-acrylic acid copolymers (EAA) or ethylene-methacrylic acid copolymers (EMAA), which are marketed by way of example with the trademarks Bynel® and Nucrel® 0609HSA by DuPont or Escor® 6000ExCo by ExxonMobil Chemicals.

According to the invention it is preferable that the adhesion between a carrier layer, a polymer layer or a barrier layer and the respective closest layer is at least 0.5 N/15 mm, preferably at least 0.7 N/15 mm and particularly preferably at least 0.8 N/15 mm. In an embodiment of the invention it is preferable that the adhesion between a polymer layer and a carrier layer is at least 0.3 N/15 mm, preferably at least 0.5 N/15 mm and particularly preferably at least 0.7 N/15 mm. It is further preferable that the adhesion between a barrier layer and a polymer layer is at least 0.8 N/15 mm, preferably at least 1.0 N/15 mm and particularly preferably at least 1.4 N/15 mm. In the event that a barrier layer follows a polymer layer indirectly by way of an adhesion-promoter layer it is preferable that the adhesion between the barrier layer and the adhesion-promoter layer is at least 1.8 N/15 mm, preferably at least 2.2 N/15 mm and particularly preferably at least 2.8 N/15 mm. In a particular embodiment the adhesion between the individual layers is so strong that the adhesion test leads to tearing of a carrier layer, the term used in the event of paperboard as carrier layer being paperboard fibre tear.

### Container Precursor

A container precursor is a precursor of a closed container produced during the production of a closed container. The container precursor here includes the sheetlike composite in cut-to-size form. The sheetlike composite here can be unfolded or folded. A preferred container precursor has been cut to size and is designed for the production of a single closed container. Another term used for a preferred container precursor which has been cut to size and is designed for the production of a single closed container is also referred to a jacket or a sleeve. The jacket or sleeve here includes the folded sheetlike composite. The jacket or sleeve moreover includes a longitudinal seam and is open in a top region and in a base region. The term tube is often used for a typical container precursor which has been cut to size and is designed for the production of a plurality of closed containers.

A preferred container precursor includes the sheetlike composite according to the invention in a manner such that the sheetlike composite has been folded at least once, preferably at least twice, more preferably at least 3 times, most preferably at least 4 times. A preferred container precursor is of a one-piece design. It is particularly preferable that a base region of the container precursor is of a one-piece design with a lateral region of the container precursor.

### Container

The closed container of the invention can have a plurality of different shapes, but preference is given to a structure that is in essence a rectangular parallelepiped. It is moreover possible that the entire area of the container is composed of the sheetlike composite, or that the container has a two- or multipart structure. In the case of a multipart structure it is conceivable that other materials are also used alongside the sheetlike composite, an example being plastic, which in particular can be used in the top or base regions of the container. However, it is preferable here that at least 50%, particularly at least 70% and more preferably at least 90%, of the area of the container is composed of the sheetlike composite. The container can moreover comprise a device for the discharge of the contents. This can by way of example be formed from plastic and applied to the external side of the container. It is also conceivable that this device has been integrated into the container via “direct injection moulding”. According to a preferred embodiment the container of the invention has at least one folded edge, preferably from 4 to 22, or even more folded edges, particularly preferably from 7 to 12 folded edges. For the purposes of the present invention the expression folded edge applies to regions produced when an area is folded. Examples of folded edges that may be mentioned are the longitudinal regions where two respective wall areas of the container meet. The container walls in the container are preferably the areas of the container, surrounded by the folded edges. It is preferable that the closed container includes no base that is not of single-piece design with the sheetlike composite or no lid that is not of single-piece design with the sheetlike composite, or both.

### Foodstuff

A preferred closed container of the invention includes a foodstuff. Materials that can be regarded as foodstuff are any of the solid or liquid foodstuffs known to the person skilled in the art for human consumption, and also those for consumption by animals. Preferred foodstuffs are liquid above 5° C., examples being dairy products, soups, sauces, and non-carbonated drinks. There are various methods for filling the container or the container precursor. A first possibility is that the foodstuff and the container or the container precursor are separately, before the filling process, sterilised to the greatest possible extent via suitable measures such as treatment of the container or of the container precursor with H₂O₂, UV radiation or other suitable high-energy radiation, plasma or a combination of at least two thereof, and also heating of the food, and that the container or the container precursor is then filled. This filling method is often termed “aseptic filling”, and is preferred according to the invention. In another method that is widely used, in addition to or else instead of aseptic filling, the container or container precursor filled with foodstuff is heated to reduce the number of germs. This is preferably achieved via pasteurisation or autoclaving. In this procedure it is also possible to use less sterile foodstuffs and containers or container precursors.

### Hole/Opening Aid

In order to provide easier opening of the closed container of the invention, a carrier layer can comprise at least one hole. In a particular embodiment the hole has been covered at least by a barrier layer, and preferably a polymer layer, particularly preferably one of the outer polymer layer, the inner polymer layer, and the intermediate polymer layer or combinations of at least two of those, as hole-covering layers. There can moreover be one or more further layers, in particular adhesion-promoter layers, provided between the abovementioned layers. It is preferable here that the hole-covering layers have been joined to one another at least to some extent, preferably at least 30%, with preference at least 70% and with particular preference at least 90% of the area formed by the hole. According to a particular embodiment it is preferable that the hole penetrates through the entire sheetlike composite and is covered by a closure or opening device that seals the hole. In connection with a preferred embodiment the hole provided in the carrier layer can have any shape that is known to the person skilled in the art and is suitable for various closures, drinking straws or opening aids. Opening of a closed container is mostly achieved by destroying, at least to some extent, the hole-covering layers covering the hole. This destruction can be achieved via cutting, pressing into the container or pulling out of the container. The destruction can be achieved via an openable closure joined to the container and arranged in the region of the hole, mostly above the hole, or via a drinking straw which is forced through the hole-covering layers covering the hole.

According to another preferred embodiment the sheetlike composite is subjected to heat treatment, at least in the region of the at least one hole. The heat treatment can be achieved via radiation, via hot gas, via thermal contact with a solid material, via mechanical oscillations, preferably via ultrasound, or via a combination of at least two of these measures. It is particularly preferable that the heat treatment is achieved via irradiation, preferably electromagnetic radiation and particularly preferably electromagnetic induction, or else via hot gas. The respective optimal operating parameters to be selected are known to the person of average skill in the art.

### TEST METHODS

The following test methods were used for the purposes of the invention. Unless otherwise stated the measurements were made at ambient temperature 25° C., ambient air pressure 100 kPa (0.986 atm) and relative humidity 50%.

### MFR Value

The MFR value is measured in accordance with the standard ISO 1133-1:2012-03 (unless otherwise stated at 190° C. with 2.16 kg).

### Density

Density is measured in accordance with the standard ISO 1183-1:2012-05.

### Melting Point

Melting point is determined according to the DSC method of ISO 11357-1 and -5. The equipment is calibrated in accordance with the manufacturer's instructions with reference to the following measurements:
indium temperature—onset temperature,
enthalpy of fusion of indium,
zinc temperature—onset temperature.

### Viscosity Number of PA

The viscosity number of PA is measured in accordance with the standard ISO 307 in 95% sulphuric acid.

### Oxygen Permeation Rate

Oxygen permeation rate is determined in accordance with the standard ISO 14663-2 Annex C at 20° C. and 65% relative humidity.

### Paperboard Moisture Content

Paperboard moisture content is measured in accordance with the standard ISO 287:2009.

### Adhesion of Layers

Adhesion between two adjacent layers is determined by fixing these onto 90° peel test equipment, for example a “German rotating wheel fixture” from Instron, on a rotating roll which rotates at 40 mm/min during the measurement. The samples were cut to size in advance, into strips of width 15 mm. At one side of the sample the sublayers are separated from one another, and the separated end is clamped into a vertically upwards oriented tensile apparatus. The tensile apparatus has attached measurement equipment for determining the tensile force. During the rotation of the roll, the force required to separate the sublayers from one another is measured. This force corresponds to the adhesion between the layers, and is stated in N/15 mm. The separation of the individual layers can be achieved by way of example mechanically, or via a specific pretreatment, for example via softening of the sample for 3 min in 30% acetic acid at 60° C.

### Molecular Weight Distribution

Molecular weight distribution is measured by gel permeation chromatography, using light scattering: ISO 16014-3/-5.

### Detection of Colourants

Detection of organic colourants can be conducted in accordance with the methods described in “Industrial Organic Pigments, Third Edition” (Willy Herbst, Klaus Hunger Copyright © 2004 WILEY-VCH Verlag GmbH & Co. KGaA, Weinheim ISBN: 3-527-30576-9).

### L-Value in the Lab Colour Space

The L-value is determined using a spectral photometer having a densitometer function of the type SpectroEye^{TM} of X-Rite, 8105 Regensdorf, Switzerland. For measuring the L-value a sample of dimension 3 cm×10 cm is cut from the laminate and measured using the spectral photometer according to the manual provided by the manufacturer of the device.

### Surface Coverage

Surface coverage is a measure of covering an area of colour appears to the normal observer. The surface coverage may be calculated using the equation of Murray-Davis. All values of surface coverage disclosed in this document have been measured with a spectral photometer (SpectroEye™) of the firm X-Rite (8105 Regensdorf, Switzerland).

### Surface Tension

In ordert o determine a surafce tension of a polymer layer and/or of an outer surface, first a contact angle of wetting with water (“water contact angle”) is determined according to the standard ATSM D5946-09. Therein, samples of dimension 30 mm×35 mm are cut from the laminate using a scalpel. 10 measurements are performed at each sample, from which the arithmetic mean is calculated. The samples are prepared as given in section 10.2 of the standard. Further, measurement conditions are chosen in accordance with section 10.4 of this standard. Using the arithmetic mean of the measured water contact angle, the surface tension in dyne/cm (dyne/cm=mN/m) is read from table X2.1 of the annex X2 of the standard.

### Adhesion Strength of Colour Applications

The term adhesion refers to the resistance of a colour application against forces produced when a strip of adhesive tape is pulled off a surface having the colour application. For the test adhesive tape of the type 4104, 20 mm width oft he manufacturer Beiersdorf AG, Hamburg, Germany is applied. The test sample is placed on a smooth, hard surface with the colour application facing upward. A strip of adhesive tape at least 30 mm in length is applied to the test sample (longitudinally and transversely to the direction of the run) and pressed down evenly with the use of the thumbs. The test is performed within 30 seconds from applying the adhesive tape. Test results may vary if the tape remains on the test sample for a longer period of time. The test is performed either by
a) pulling back the adhesive tape quickly at an angle of 90°, or
b) peeling of the adhesive tape slowly at an angle to the surface having the colour application of less than 45°.

Both types of test a) and b) are performed 3 times at different positions of the colour application. The results are classified according to the following scale from 5 to 1.
5—colour application is not removed
4—colour application is removed locally in individual places
3—colour application is clearly removed in individual places
2—colour application is removed over large areas
1—colour application is removed completely

The overall result of the 6 tests of a sample is determined by calculating the arithmetic mean of the 6 individual results.

### Mechanical Resistance at Elevated Temperature and Moisture

The laminates to be tested are placed in a water bath where they are exposed to temperature and moisture for 60 seconds at 94° C. The water bath is prepared in a beaker and the water is continuously stirred by a magnetic stirrer in order to obtain a flat special temperature distribution. Temperature is checked for using a thermometer and the time is measured using a stop watch. After 60 seconds, the laminate remains in the water bath and a glass rod having rounded ends is used to apply moderate pressure by rubbing an end of the glass rod over the colour application. Subsequently, the laminate is removed from the water bath and visually inspected for damages to the colour application with the naked eye. For each sample 3 tests are performed at different positions of the laminate. During these tests, attention should be paid to applying the rubbing for about the same duration and with the same force for each test. Here, each test of a sequence of tests to be compared should be performed by the same person. Assessment of the results is done using the following scale.
1—colour application can be scratched of completely
2—colour application shows strong signs of damage
3—colour application shows less strong but still significant signs of damage
4—colour application shows only slight signs of damage
5—colour application shows no signs of damage

The overall result of the 3 tests of a sample is determined by calculating the arithmetic mean of the 3 individual results.

### Staining at Elevated Temperature

Staining at elevated temperature refers to the ability of hardened colour applications not to adhere to the inner surface of the same laminate on a reel. For the test 4 samples of the same size (dimensions 10 cm×20 cm) are cut from the laminate. These samples are stacked, wherein in the stack outer surfaces and inner surfaces of the laminates touch each other. The stack is placed between two glass plates (dimensions 20 cm×30 cm) and transferred to a heating cabinet. A pair of 1 kg weights is placed on top of the stack. The stack remains in the oven for 6 days at a temperature of 70° C. Then the stack is cooled to room temperature and removed from the heating cabinet. The single layers are separated carefully. Each colour application which has been in contact with an inner surface of another sample in the stack as well as these inner surfaces are visually inspected for transfer of colour from the colour application to the inner surface using the bare eye.

### Impairment of Taste

Determining the impairment of taste of a foodstuff stored in a closed container includes storing the foodstuff in the container for 90 days at 25° C. In parallel, the same foodstuff is stored in glass bottles in a dark room for the same time and at the same temperature. After the storage time the taste of the stored foodstuff is tested by a panel of 10 test persons. Differences between the foodstuffs stored in the laminate container and in the glass bottles are assessed on the following scale.

1—no sensible difference in taste
2—difference in taste slightly sensible
3—moderate differences in taste
4—severe differences in taste
5—strong differences in taste

### Symbol Contrast

The symbol contrast of the 2D-code is determined according to the standard ISO/IEC 15415: 2011(E).

### Unused Error Correction Parameter

The unused error correction parameter t of the 2D-code is determined according to the standard ISO/IEC 15415: 2011(E).

### Axial Non-Uniformity

The axial non-uniformity of the 2D-code is determined according to the standard ISO/IEC 15415: 2011(E).

The invention is described in more detail below via Examples and drawings, wherein the Examples and drawings do not imply any restriction of the invention. The drawings are moreover diagrammatic and not true to scale.

For the examples (inventive) and comparative examples (non-inventive), laminates with the following layer sequence were produced by means of an extrusion coating system which is standard in laminar extrusion processes.

TABLE 1
layer sequence used in the examples (inventive)
and comparative examples (non-inventive) below

| | | grammage |
|---|---|---|
| layer | material | [g/m²] |
| outer polymer | LDPE 19N430 of Ineos GmbH, Cologne, | 15 |
| layer | Germany | |
| carrier layer | paper board: Stora Enso Natura T | 210 |
| | Duplex, double coating layer, Scott-Bond | |
| | 200 J/m², residual moisture 7.5% | |
| intermediate | LDPE 19N430 of Ineos GmbH, Cologne, | 18 |
| polymer layer | Germany | |
| barrier layer | aluminium foil EN AW 8079 of Hydro | here: |
| | Aluminium Deutschland GmbH | thickness |
| | | 6 μm |
| adhesion | co-extrudate (1) Escor 6000 HSC of | (1) - 4 |
| promoter | Exxon Mobil Corporation and (2) LDPE | (2) - 22 |
| layer | 19N430 of Ineos GmbH, Cologne, | |
| | Germany | |
| inner polymer | blend of (1) 65 wt.-% LDPE 19N430 of | 10 |
| layer | Ineos GmbH, Cologne, Germany and | |
| | (2) 35 wt.-% Eltex 1315 AZ of Ineos | |
| | GmbH, Cologne, Germany | |

### Laminate Production

Laminates consisting of the layers given in table 2 above are produced applying an extrusion coating system of the firm Davis Standard. Therein, the extrusion temperature is in the range from about 280 to 310° C. Temperature variations of ±6° C. are understood to be within normal tolerances. Grammage variations of ±3 g/m² are within normal tolerances as well. In a first step, one hole for each container to be produced from the laminate is applied to the carrier layer by die cutting. Subsequently, the outer polymer layer is applied to the carrier layer, thereby covering the holes. In a following step, the barrier layer is applied to the carrier layer together with the intermediate polymer layer. Subsequently, the adhesion promoter layer and the inner polymer layer are co-extruded onto the barrier layer. In order to allow for applying of the several polymer layers, the polymers are molten in an extruder. For applying a polymer of a layer, the obtained polymer melt is fed via a feed block into a nozzle and from there extruded to the substrate.

The laminates obtained as described above are further processed as follows. First the surface of the outer polymer layer which is facing away from the carrier layer is corona treated. For the corona treatment a device AVE-250E of the firm AFS Entwicklungs- and Vertriebs GmbH, Germany is used. Power and voltage of the corona treatment are adjusted to obtain the surface tensions after the first corona treatment as given in table 2 below. Therein, the surface tension needs to be measured immediately after the corona treatment as the surface tension which has been increased by the treatment may decrease again over time, usually on a scale of several days. In a next step, immediately after the first corona treatment a decoration is printed by intaglio printing onto the outer polymer layer. Here, 4 printing inks—each of the type VB67 from Siegwerk Druckfarben AG, Siegburg, Germany, and each ink of a different colour of a four-colour-print system—are printed onto the outer polymer layer. Therein, each ink is printed by a standard intaglio printing unit of the firm Kochsiek, Germany. After each printing the printed ink is dried in a stream of air for 1 minute at 60° C. Thus, a four-colour print decoration is obtained. The decoration thus obtained does not cover an area of the size of 3 cm×3 cm of the outer polymer layer. Hence, this area remains unprinted. In a next step a second corona treatment is applied to the outer surface of the laminate, which is has been partially printed. Power and voltage of the second corona treatment are adjusted to obtain the surface tensions after the second corona treatment as given in table 2 below. Therein, again the surface tension needs to be measured immediately after the corona treatment. In the comparative example 2 no second corona treatment is applied. Immediately after the second corona treatment, if conducted, a QR-code is printed via an inkjet printer by Konika Minolta of the firm Industrial Inkjet Ltd., Great Britain onto the unprinted area of the outer polymer layer. Black ink of the type Sunjet ULM from Sun Chemical, USA is used for printing the QR-code. In a next step the inkjet-printed ink is cured by irradiation with UV-light.

TABLE 2
values of surface tension of the outer polymer layer
measured immediately after corona treatment

| | surface tension | surface tension |
|---|---|---|
| | after first | after second |
| | corona treatment | corona treatment |
| | [dyne/cm] | [dyne/cm] |
| example 1 | 40 | 48 |
| example 2 | 40 | 46 |
| example 3 | 39 | 44 |
| example 4 | 38 | 42.5 |
| comparative example 1 | 38 | 38 |
| comparative example 2 | 40 | / |

The printed laminates obtained as described above are tested for adhesion strength of the decoration and the OR-code, staining of the decoration and the QR-code at elevated temperature and mechanical resistance of the decoration and the QR-code at elevated temperature and moisture. Further, the unused error correction parameter of the printed OR-code is measured. The preceding tests are performed as described above in the test methods section. The results are shown in table 3 below. Therein, entries with a “1” give the result for the decoration at the left hand side of the “/” and the result for the QR-code on the right hand side of the “/”.

### Container Production

The printed laminates are creased, thereby obtaining crease lines in the laminates. In particular, longitudinal crease lines are introduced. Further, the laminates are cut into sections, wherein each section is suitable for producing a single container from it. Therein, each of the sections comprises one of the holes mentioned above. From each section a container precursor in form of a sleeve as shown in FIG. 5 is obtained by folding along the 4 longitudinal crease lines and sealing of overlapping fold areas onto each other, thereby obtaining a longitudinal seam. From this container precursor, a closed container as shown in FIG. 6 (“brick-type”) is formed using a standard filling machine CFA 712 of SIG Combibloc, Linnich, Germany. Therein, a bottom region is formed by folding and closed by heat sealing. Thus, a cup with an open top region is obtained. The cup is sterilised using hydrogen peroxide. Further, the cup is filled with long-life milk. By further folding and ultrasound sealing the top region of the cup, having the hole, is closed. Thus, a closed and filled container is obtained. Further, an opening aid is attached to the container, covering the hole. The closed containers thus obtained are stored and afterwards the taste of the milk is tested as described above in the test method “impairment of taste”.

### Assessment

TABLE 3
Results of measurements for the examples and comparative
examples, wherein entries with a “/” are
of the form “decoration/QR-code”

| | adhesion | mechanical | | impair- | |
|---|---|---|---|---|---|
| | strength | resistance | | ment | unused |
| | of colour | at elevated | staining at | of taste | error |
| | appli- | temperature | elevated | of the | correction |
| | cations | and moisture | temperature | milk | parameter |
| example 1 | 5/5 | 5/5 | ++/+++ | 5 | − |
| example 2 | 5/5 | 5/5 | ++/+++ | 3 | + |
| example 3 | 4/5 | 4/4 | +/++ | 2 | + |
| example 4 | 3/4 | 3/3 | +/+ | 1 | + |
| compar- | 3/2 | 3/2 | +/− | 1 | − |
| ative | | | | | |
| example 1 | | | | | |
| compar- | 5/1 | 5/1 | ++/−− | 1 | −− |
| ative | | | | | |
| example 2 | | | | | |

In the above table 3, +++ marks a results which is more desirable than ++, which marks a result which is more desirable than +, which marks a result which is more desirably than −, which marks a result which is still more desirable than −−. Therein, as few staining at elevated temperature as possible and an as high as possible unused error correction parameter are desired.

### BRIEF DESCRIPTIONS OF THE DRAWINGS

FIG. 1 is a diagrammatic cross section through a sheetlike composite of the invention;

FIG. 2 is a diagrammatic top view of the sheetlike composite of FIG. 1;

FIG. 3 is a diagrammatic cross section through a sheetlike composite precursor applied in a process of the invention;

FIG. 4 is a flow diagram of a process of the invention;

FIG. 5 is a diagrammatic view of a container precursor of the invention; and

FIG. 6 is a diagrammatic view of a closed container of the invention.

### LIST OF REFERENCE NUMERALS

100 sheetlike composite of the invention
101 outer surface of the sheetlike composite
102 inner surface of the sheetlike composite
103 outer polymer layer
104 carrier layer
105 intermediate polymer layer
106 barrier layer
107 adhesion promoter layer
108 inner polymer layer
109 first colour application
110 second colour application
201 first composite region
202 second composite region
203 third composite region
300 sheetlike composite precursor
301 outer surface of the sheetlike composite precursor
302 inner surface of the sheetlike composite precursor
400 process of the invention
401 process step a)
402 process step b)
403 process step c)
404 process step d)
405 process step e)
406 process step f)
500 container precursor of the invention
501 longitudinal fold/longitudinal edge
502 longitudinal seam
503 top region
504 bottom region
505 hole
506 crease line
600 closed container of the invention
601 foodstuff
602 cap with opening aid

### DETAILED DESCRIPTIONS

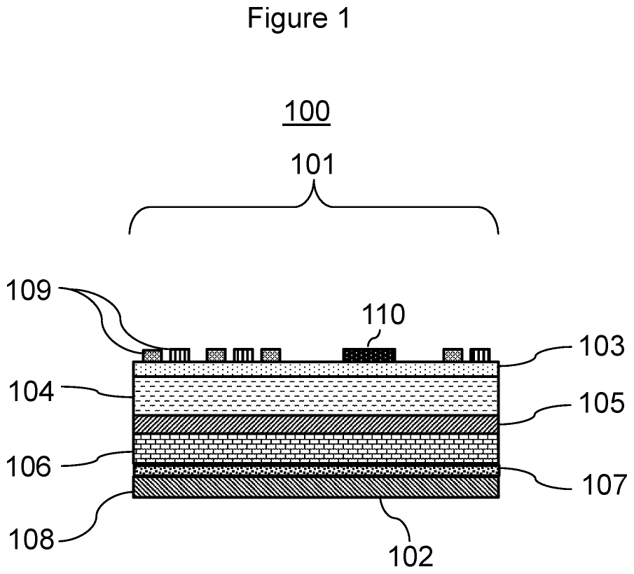

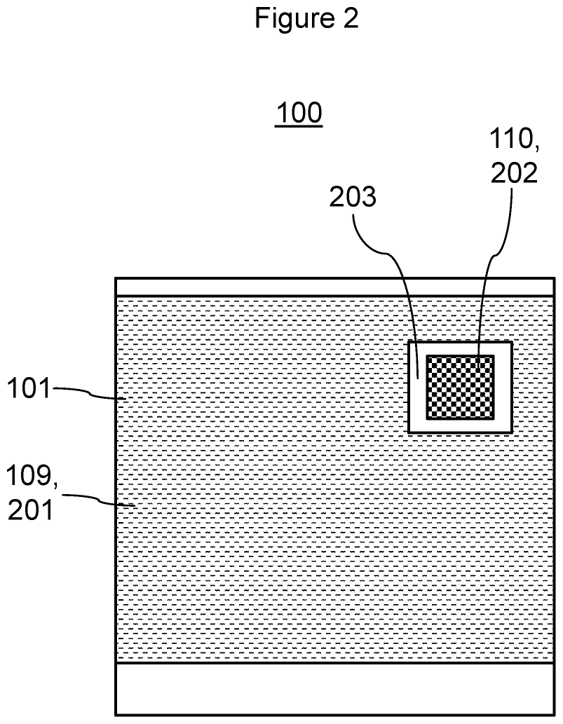

FIG. 1 shows a diagrammatic cross section through a sheetlike composite 100 of the invention. The sheetlike composite 100 comprises an outer surface 101 and an inner surface 102. In a direction from the outer surface 101 to the inner surface 102, the sheetlike composite 100 comprises as layers of a layer sequence: an outer polymer layer 103 made of LDPE 19N430 of the firm Ineos GmbH, Cologne (grammage 15 g/m²); a carrier layer 104 made of a cardboard Stora Enso Natura T Duplex with double coating layer (Scott-Bond 200 J/m², residual moisture 7.5%, grammage 210 g/m²); an intermediate polymer layer 105 made of LDPE 19N430 of Ineos GmbH, Cologne (grammage 18 g/m²); a barrier layer 106 made of an aluminium foil EN AW 8079 of Hydro Aluminium Deutschland GmbH (thickness 6 μm); an adhesion promoter layer 107 made of Escor 6000 HSC of the Exxon Mobil Corporation (grammage 4 g/m²) and LDPE 19N430 of Ineos GmbH, Cologne (grammage 22 g/m²); and an inner polymer layer 108 made of a blend from 65% by weight LDPE 19N430 of Ineos Cologne GmbH and 35% by weight Eltex 1315 AZ of Ineos Cologne GmbH (grammage of the blend 10 g/m²). Further, the sheetlike composite 100 comprises a first composite region 201 and a second composite region 202 (see for both FIG. 2). In the first composite region 201, the sheetlike composite 100 further comprises a first colour application 109, partially covering the outer polymer layer 103 on a side of the outer polymer layer 103 which is facing away from the inner surface 102 of the sheetlike composite 100. This first colour application 109 is a decoration of the sheetlike composite 100. This decoration consists of matrix dots, obtained by rotogravure printing two different inks of the series VB67 from Siegwerk Druckfarben AG, Siegburg, Germany onto the outer polymer layer 103 in the first composite region 201. Hence, the decoration comprises 2 different colours. Furthermore, in the second composite region 202 the sheetlike composite 100 further comprises a second colour application 110, which covers the outer polymer layer 103 on the side of the outer polymer layer 103 which is facing away from the inner surface 102 of the sheetlike composite 100. Therein, the second colour application 110 is a QR-code obtained by inkjet-printing a black ink Sunjet ULM from Sun Chemical, USA onto the outer polymer layer 103. This QR-code consists of 177×177 graphic elements, including printed black areas and white gaps between those black areas. Therein, the gaps are unprinted area in which the white colour (L-value in the Lab colour space of 91.2) of the layers underneath show through. The graphic elements are a graphic representation of a sequence of 23.648 kbits. The QR-code is characterised by a symbol contrast of 80%, an axial non-uniformity of 0.02, and an unused error correction parameter of 0.84.

FIG. 2 shows a diagrammatic top view of the sheetlike composite 100 of FIG. 1. Therein, FIG. 2 shows the first composite region 201 having the first colour application 109, the second composite region 202 having the second colour application 110, and a third composite region 203, which separates the first composite region 201 from the second composite region 202 by framing the second composite region 202. Therein, the third composite region 203 has width of 2 mm. In the third composite region 203 the outer polymer layer 103 is not superimposed by any layer of the sheetlike composite 100 on the side of the outer polymer layer 103 which faces away from the carrier layer 104. In particular, in the third composite region 203 the outer polymer layer 103 is an outermost layer of the sheetlike composite 100. In the first composite region 201 the outer surface 101 has a first surface tension of 44 dyne/cm. The first colour application 109 has a surface coverage of 100%, based on a surface area of the first composite region 201 which is 80% of the outer surface 101 of the sheetlike composite 100. In the second composite region 202 the outer surface 101 has a second surface tension of 40.8 dyne/cm. The second colour application 110 has a surface coverage of 50%, based on a surface area of the second composite region 202 which is about 4% of the outer surface 101 of the sheetlike composite 100. In the third composite region 203 the outer surface 101 has a third surface tension of 38 dyne/cm. A surface area of the third composite region 203 is about 3% of the outer surface 101 of the sheetlike composite 100.

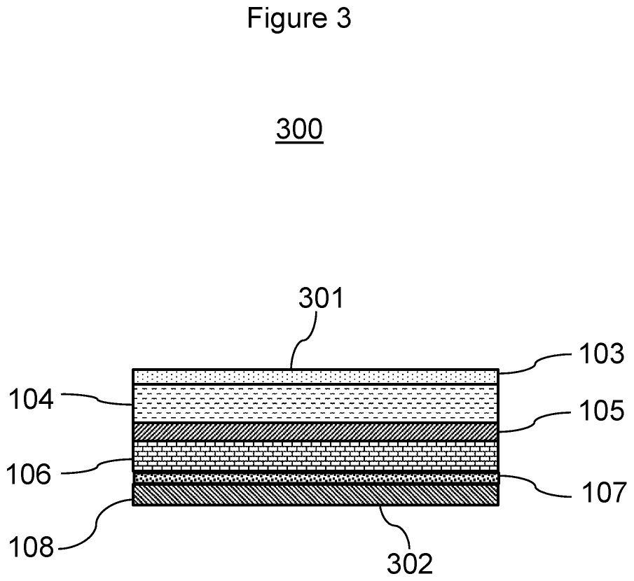

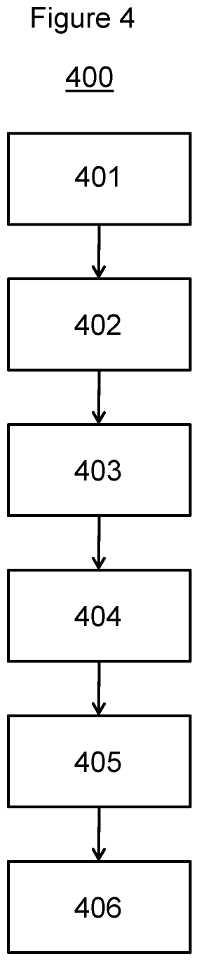

FIG. 3 shows a diagrammatic cross section through a sheetlike composite precursor 300 applied in a process 400 of the invention. The sheetlike composite precursor 300 comprises an outer surface 301 and an inner surface 302. In a direction from the outer surface 301 to the inner surface 302, the sheetlike composite precursor 300 comprises as layers of a layer sequence: an outer polymer layer 103; a carrier layer 104; an intermediate polymer layer 105; a barrier layer 106; an adhesion promoter layer 107; and an inner polymer layer 108. Each of the preceding layers of the sheetlike composite 300 correspond to and are identical to layers of the same name of the sheetlike composite 100 shown in FIG. 1. By treating the outer surface 301 and printing onto the outer polymer layer 103 according to the process 400 of FIG. 4, the sheetlike composite 100 of FIG. 1 can be obtained from the sheetlike composite precursor 300.

FIG. 4 shows a flow diagram of a process 400 of the invention. The process 400 comprises a process step a) 401 of proving the sheetlike composite precursor 300 of FIG. 3. In a further process step b) 402 a surface tension of the outer surface 301 is increased by a first corona treatment to 41 dyne/cm. Within 30 seconds from the first corona treatment, a first ink composition is rotogravure-printed onto the outer surface 103 in a first composite precursor region in a process step c) 403. After the first ink composition has been dried and thereby hardened a further ink composition is rotogravure-printed onto the outer surface 103 in the first composite precursor region. Both, the first and the further ink composition, are inks of the series VB67 from Siegwerk Druckfarben AG, Siegburg. Therein, the first and the further ink compositions each have a different colourant, thus a different colour. By drying and thereby hardening the first and the further ink compositions, the first colour application 109 of FIG. 1 is obtained. In a further process step d) 404 a surface tension of the outer surface 301 in a second composite precursor region is increased by a further corona treatment to 46 dyne/cm. In the process step d) 404 the outer surface 301 is formed partially by the outer polymer layer 103 and the first colour application 109. In the second composite precursor region the outer surface 301 is formed by the outer polymer layer 103 in the process step d) 404. Within 30 seconds from the further corona treatment, a second ink composition is inkjet-printed onto the outer surface 103 in the second composite precursor region in a process step e) 405. In a subsequent process step f) 406 the second ink composition is hardened, thereby obtaining the second colour application 110 of FIG. 1. The hardening in step f) 406 comprises irradiating the second ink composition with UV-light to activate a photo-initiator comprised by the second ink composition. Hence, this hardening comprises a crosslinking reaction. During the process steps b) 402 to f) 406, the sheetlike composite precursor 300 is moved with a velocity of about 600 m/min via propelled rollers and deflecting rollers.

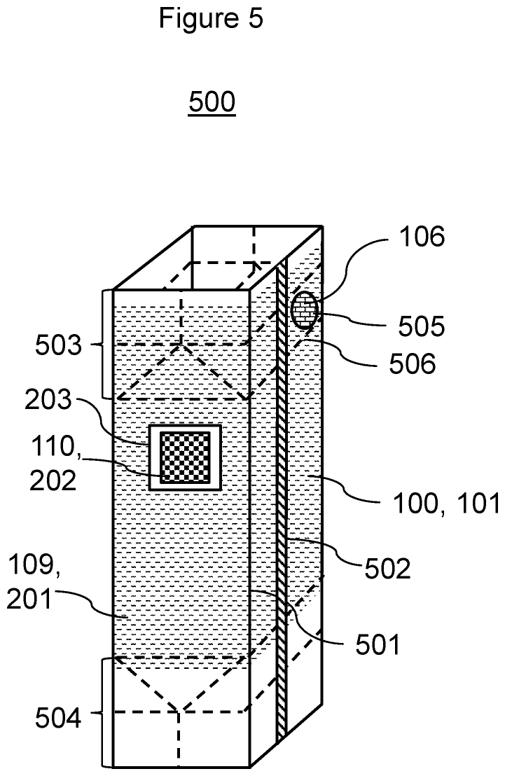

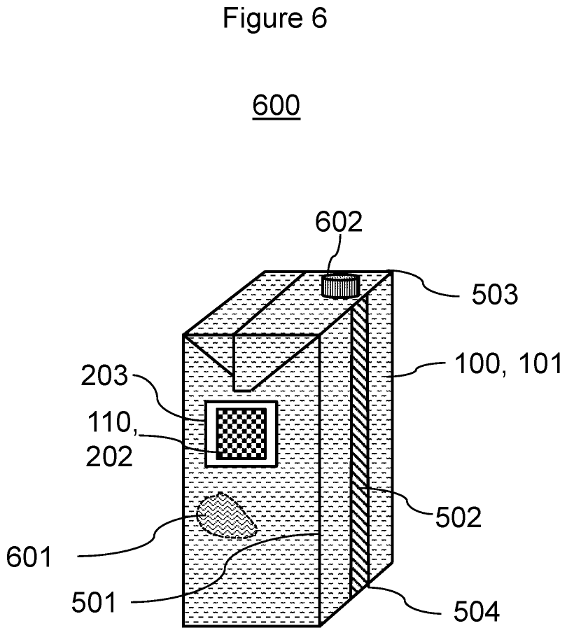

FIG. 5 shows a diagrammatic view of a container precursor 500 of the invention. The container precursor 500 shown here is a sleeve. Further, the sleeve includes a top region 503 and a bottom region 504. The top region 503 and the bottom region 504 respectively include crease lines 506. The top region 503 and the bottom region 504 can respectively be closed by folding along the creases 506 and sealing, and a closed container 600 as shown in FIG. 6 can thus be obtained from the sleeve. Accordingly, the container precursor 500 is a precursor produced in the process for producing the closed container 600. The container precursor 500 here includes a cut-to-size section of the sheetlike composite 100 of FIG. 1. In the container precursor 500 the sheetlike composite 100 has been folded; here it includes 4 longitudinal folds 501, which are also 4 longitudinal edges 501 of the container precursor 500. The sleeve moreover includes a longitudinal seam 502 along which end regions of the section of the sheetlike composite 100 have been sealed to one another. The container precursor 500 further comprises a hole 505 in the carrier layer 104. This hole 505 is covered by the outer polymer layer 103 (not shown here), the intermediate polymer layer 105 (not shown here), the barrier layer 106, the adhesion promoter layer 107 (not shown here) and the inner polymer layer 108 (not shown here) as hole-covering layers. As can be seen in FIG. 5, the outer surface 101; having the first composite region 201 with the first colour application 109 (decoration), the second composite region 202 with the second colour application 110 (QR-code), and the third composite region 203 framing the second composite region 202; is facing outward, hence to the environment of the container precursor 500.

FIG. 6 shows a diagrammatic view of a closed container 600 of the invention.

The closed container 600 can be obtained via folding of the container precursor 500 of FIG. 5 along the crease lines 506 and sealing of folded regions to seal the top region 503 and the bottom region 504. Accordingly, the closed container 600 includes a cut-to-size section of the sheetlike composite 100 of FIG. 1. The closed container 600 further includes at least 12 edges, 4 of which are the longitudinal edges 501 mentioned in the context of the FIG. 5. The closed container 600 surrounds an interior which includes a foodstuff 601. The foodstuff can be liquid, but can also include solid constituents. The closed container 600 shown in FIG. 6 is of one-piece design. The closed container 600 can moreover be provided with a fitment to improve ease of opening. Here, the hole 505 in the carrier layer 104 of the sheetlike composite 100 is covered by a cap 602 with an opening aid which is attached to the closed container 600.

1. A sheetlike composite, comprising as layers of a layer sequence in a direction from an outer surface of the sheetlike composite to an inner surface of the sheetlike composite
a) an outer polymer layer,
b) a carrier layer, and
c) a barrier layer;
wherein the sheetlike composite comprises a first composite region and a second composite region;
wherein in the first composite region the sheetlike composite further comprises a first colour application, superimposing the outer polymer layer on a side of the outer polymer layer which is facing away from the inner surface of the sheetlike composite;
wherein in the second composite region the sheetlike composite further comprises a second colour application, superimposing the outer polymer layer on the side of the outer polymer layer which is facing away from the inner surface of the sheetlike composite;
wherein the second colour application comprises a 2D-code.

2. The sheetlike composite according to claim 1, wherein the first colour application or the second colour application or both adjoins/adjoin the outer polymer layer.

3. The sheetlike composite according to claim 1, wherein the second colour application is not superimposed by any layer of the sheetlike composite on a side of the second colour application which is facing away from the outer polymer layer.

4. The sheetlike composite according to claim 1, wherein the first colour application is not superimposed by any layer of the sheetlike composite on a side of the first colour application which is facing away from the outer polymer layer.

5. The sheetlike composite according to claim 1, wherein in the first composite region the outer surface of the sheetlike composite has a first surface tension,
wherein in the second composite region the outer surface of the sheetlike composite has a second surface tension,
wherein the first surface tension is more than the second surface tension.

6. The sheetlike composite according to claim 1, wherein the 2D-code has a symbol contrast of at least 20%.

7. A process, comprising as process steps
a) providing a sheetlike composite precursor, comprising as layers of a layer sequence in a direction from an outer surface of the sheetlike composite precursor to an inner surface of the sheetlike composite precursor
i) an outer polymer layer,
ii) a carrier layer, and
iii) a barrier layer;
b) adapting a surface tension of the outer surface at least in a first composite precursor region to a first value;
c) applying a first ink composition onto the outer surface in the first composite precursor region;
d) adapting the surface tension of the outer surface at least in a second composite precursor region to a further value; and
e) applying a second ink composition onto the outer surface in the second composite precursor region;
wherein the further value is more than the first value.

8. The process according to claim 7, wherein the outer surface is a surface of the outer polymer layer.

9. The process according to claim 7, wherein the first value is in the range from 36 to 42 dyne/cm.

10. The process according to claim 7, wherein the further value is in the range from 42.5 to 46 dyne/cm.

11. The process according to claim 7, wherein between the process steps c) and d) the process further comprises a hardening of the first ink composition, thereby obtaining a first colour application,
wherein the process further comprises a process step
f) hardening of the second ink composition, thereby obtaining a second colour application,
wherein the second colour application comprises a 2D-code.

12. The process according to claim 11, wherein the 2D-code comprises a graphic representation of a sequence of bits.

13. The process according to claim 11, wherein the 2D-code has a symbol contrast of at least 20%.

14. A sheetlike composite, obtainable by the process according to claim 7.

15. A container precursor, at least comprising a pre-cut of the sheetlike composite according to claim 1.

16. A closed container, at least comprising a pre-cut of the sheetlike composite according to claim 1.

17. A use of the sheetlike composite according to claim 1 for producing a foodstuff container.

18. A method of printing a 2D-code directly onto an outer polymer layer of a sheetlike composite, using an inkjet printer,
wherein the sheetlike composite comprises as layers of a layer sequence in a direction from an outer surface of the sheetlike composite to an inner surface of the sheetlike composite
a) the outer polymer layer,
b) a carrier layer, and
c) a barrier layer.
